(19) United States
(12) Patent Application Publication
(10) Pub. No.: US 2026/0154944 A1
(43) Pub. Date: Jun. 4, 2026

(54) METHOD AND SYSTEM FOR ROOM SCENE GROUPING

(71) Applicant: Expedia, Inc., Seattle, WA (US)

(72) Inventors: Mani Najmabadi, Seattle, WA (US); Shayan Hassantabar, Seattle, WA (US); Vignesh Ram Nithin Kappagantula, Seattle, WA (US)

(73) Assignee: Expedia, Inc., Seattle, WA (US)

(21) Appl. No.: 19/401,156

(22) Filed: Nov. 25, 2025

Related U.S. Application Data
(60) Provisional application No. 63/728,088, filed on Dec. 4, 2024.

(51) Int. Cl. G06V 10/762; G06N 3/048; G06V 10/82; G06V 20/10

(52) U.S. Cl. CPC G06V 10/7635; G06N 3/048; G06V 10/82; G06V 20/10

(57) ABSTRACT

Various examples, systems, and methods are disclosed relating to processing, classifying, and grouping images. A first computing system can cause an encoder model to generate a plurality of scenes corresponding with a plurality of images. The first computing system further can cause a detection model to generate a plurality of similarity metrics of a plurality of image pairs of a plurality of spaces of the plurality of images corresponding with at least one scene. The first computing system further can determine a plurality of image subsets of the plurality of spaces of the plurality of images corresponding with the at least one scene, the plurality of image subsets are determined based at least on a grouping of the plurality of images according to the plurality of similarity metrics. The first computing system further can provide the plurality of image subsets of the plurality of images.

### CROSS-REFERENCE TO RELATED APPLICATIONS

The present application claims the benefit of U.S. Provisional Patent Application No. 63/728,088, filed Dec. 4, 2024, the disclosure of which is incorporated herein by reference in its entirety.

### BACKGROUND

Systems for grouping and classifying images of indoor spaces, such as vacation rentals or hotels, often rely on manual tagging or predefined heuristics, which can be limited in effectively organizing images into meaningful subsets representing distinct spaces. Techniques such as rule-based classification or static feature matching have a restricted capacity to manage diverse datasets, particularly when images are inconsistent in lighting, perspective, or content. These limitations can result in misclassifications, inefficiencies in organizing large-scale image datasets, and increased reliance on manual intervention. For example, conventional methods often fail to distinguish between images of similar-looking spaces, such as two different bedrooms or bathrooms within the same property, leading to ambiguities and inaccuracies.

### SUMMARY

Some implementations relate to one or more processors including processing circuitry to cause an encoder model to generate a plurality of scenes corresponding with a plurality of images. The one or more processors including the processing circuitry to cause a detection model to generate a plurality of similarity metrics of a plurality of image pairs corresponding with a plurality of spaces of the plurality of images corresponding with at least one scene of the plurality of scenes. The one or more processors including the processing circuitry to determine a plurality of image subsets of the plurality of spaces of the plurality of images corresponding with the at least one scene of the plurality of scenes. In some implementations, the plurality of image subsets are determined based at least on a grouping of the plurality of images according to the plurality of similarity metrics. In some implementations, at least one of the plurality of image subsets corresponds with at least one space of the plurality of spaces. The one or more processors including the processing circuitry to provide, to an interface system, the plurality of image subsets of the plurality of images.

Some implementations relate to a system for grouping a plurality of images associated with a plurality of scenes. The system including processing circuitry configured to cause an encoder model to identify at least one scene of the plurality of scenes for each image of the plurality of images. The system including processing circuitry configured to cause a detection model to generate a plurality of similarity metrics of a plurality of image pairs corresponding with a plurality of spaces of at least one of the plurality of scenes. The system including processing circuitry configured to determine a plurality of image subsets of the plurality of spaces of the plurality of images corresponding the at least one of the plurality of scenes, the plurality of image subsets are determined based at least on a grouping of the plurality of images according to the plurality of similarity metrics, wherein at least one of the plurality of image subsets corresponds with at least one space of the plurality of spaces. The system including processing circuitry configured to provide the plurality of image subsets of the plurality of images.

In some implementations, causing the encoder model to identify the at least one scene of the plurality of scenes for each image of the plurality of images includes at least one of tagging one or more objects in at least one image of the plurality of images, determining a scene of the plurality of scenes of the at least one image of the plurality of images, or identifying one or more features in the at least one image of the plurality of images.

In some implementations, the processing circuitry is configured to determine a sub-space of the at least one image of the plurality of images based at least on the one or more objects and the one or more features, wherein the at least one image of the plurality of images of the plurality of image subsets include metadata corresponding to the sub-space.

In some implementations, at least one similarity metric of the plurality of similarity metrics corresponds to a pairwise overlap score between a first image of the plurality of images with the at least one scene and a second image of the plurality of images with the at least one scene.

In some implementations, causing the detection model to generate the plurality of similarity metrics includes extracting, using a shared neural network of the detection model, a first feature vector of the first image and a second feature vector of the second image, combining, using a vector function corresponding to a pairwise processing of one or more components of the first feature vector and the second feature vector, the first feature vector and the second feature vector to output a combined feature vector, transforming the combined feature vector using a dense layer of the detection model to generate an intermediate score, and applying an activation function to output the pairwise overlap score.

In some implementations, the processing circuitry configured to update the detection model based at least on (i) annotated positive image pairs, (ii) self-supervised positive image pairs, and (iii) negative image pairs, wherein the self-supervised positive image pairs are generated by applying one or more transformations including at least one of cropping, rotation, scaling, or color space adjusting to one or more images of the plurality of images, and wherein the annotated positive image pairs are generated by determining overlap between one or more views of a same space of the plurality of spaces, and wherein the negative image pairs are generated by determining a first image of a first space within the at least one scene and a second image of a second space within the at least one scene.

In some implementations, the plurality of similarity metrics are encoded within a similarity matrix, the similarity matrix including a two-dimensional (2D) array, and wherein each element of the 2D array corresponding to a similarity metric between a pair of images of the plurality of images, and wherein the similarity matrix is represented as a heatmap, the heatmap including degrees of similarity between the plurality of image pairs using a color gradient.

In some implementations, the plurality of spaces include at least one of a bedroom, a bathroom, a kitchen, a living room, an entryway, a dining area, a laundry room, an office, a balcony, a patio, a garage, a storage area, or one or more outdoor spaces.

In some implementations, the plurality of image subsets are determined further based at least on a space count of at least one of the plurality of scenes, and wherein determining the plurality of image subsets includes applying a clustering function to the plurality of similarity metrics to cluster the plurality of images into the plurality of image subsets corresponding to a space of the plurality of spaces.

Some implementations relate to a method for grouping a plurality of images associated with a plurality of scenes. The method includes causing, by one or more processing circuits, a first model to identify at least one scene of the plurality of scenes for each image of the plurality of images. The method includes causing, by the one or more processing circuits, a second model to generate a plurality of similarity metrics of a plurality of image pairs corresponding with a plurality of spaces of at least one of the plurality of scenes. The method includes determining, by the one or more processing circuits, a plurality of image subsets of the plurality of spaces of the plurality of images corresponding with at least one of the plurality of scenes, the plurality of image subsets are determined based at least on a grouping of the plurality of images according to the plurality of similarity metrics, wherein at least one of the plurality of image subsets corresponds with at least one space of the plurality of spaces. The method includes providing, by the one or more processing circuits to an interface system, the plurality of image subsets of the plurality of images.

In some implementations, causing the first model to identify the at least one scene of the plurality of scenes for each image of the plurality of images includes at least one of tagging one or more objects in at least one image of the plurality of images, determining a scene of the plurality of scenes in the at least one image of the plurality of images, or identifying one or more features in the at least one image of the plurality of images.

In some implementations, at least one similarity metric of the plurality of similarity metrics corresponds to a pairwise overlap score between a first image of the plurality of images with the at least one scene and a second image of the plurality of images with the at least one scene.

In some implementations, causing the second model to generate the plurality of similarity metrics includes extracting, using a shared neural network of the second model, one or more feature vectors of the first image and the second image, combining, using a vector function corresponding to a pairwise processing of one or more components of the one or more feature vectors, the one or more feature vectors to output a combined feature vector, transforming the combined feature vector using a dense layer of the second model to generate an intermediate score, and applying an activation function to output the pairwise overlap score.

In some implementations, the method further including updating, by the one or more processing circuits, the second model based at least on (i) annotated positive image pairs, (ii) self-supervised positive image pairs, and (iii) negative image pairs.

In some implementations, the self-supervised positive image pairs are generated by applying one or more transformations including at least one of cropping, rotation, scaling, or color space adjusting to one or more images of the plurality of images, and wherein the annotated positive image pairs are generated by determining overlap between one or more views of a same space of the plurality of scenes, and wherein the negative image pairs are generated by determining a first image of a first space within the at least one scene and a second image of a second space within the at least one scene.

In some implementations, the plurality of similarity metrics are encoded within a similarity matrix, the similarity matrix including a two-dimensional (2D) array, and wherein each element of the 2D array corresponding to a similarity metric between a pair of images of the plurality of images, and wherein the similarity matrix is represented as a heatmap, the heatmap including degrees of similarity between the plurality of image pairs using a color gradient.

In some implementations, the plurality of spaces include at least one of a bedroom, a bathroom, a kitchen, a living room, an entryway, a dining area, a laundry room, an office, a balcony, a patio, a garage, a storage area, or one or more outdoor spaces.

In some implementations, the plurality of image subsets are determined further based at least on a space count of at least one of the plurality of scenes, and wherein determining the plurality of image subsets includes applying a clustering function to the plurality of similarity metrics to cluster the plurality of images into the plurality of image subsets corresponding to a space of the plurality of spaces.

Some implementations relate to one or more non-transitory computer readable media for determining and organizing one or more spaces of a hotel or a rental property corresponding with a plurality of images, the one or more non-transitory computer readable media having one or more instructions stored thereon that, upon execution by one or more processors, cause the one or more processors to identify, using an encoder model, at least one space type of a plurality of space types for each image of the plurality of images of a plurality of accommodations of the hotel or the rental property. The one or more non-transitory computer readable media for determining and organizing the one or more spaces of the hotel or the rental property corresponding with the plurality of images, the one or more non-transitory computer readable media having the one or more instructions stored thereon that, upon execution by the one or more processors, cause the one or more processors to generate, using a detection model, a plurality of similarity metrics of a plurality of image pairs corresponding with the one or more spaces of at least one of the plurality of space types. The one or more non-transitory computer readable media for determining and organizing the one or more spaces of the hotel or the rental property corresponding with the plurality of images, the one or more non-transitory computer readable media having the one or more instructions stored thereon that, upon execution by the one or more processors, cause the one or more processors to generate, using the plurality of similarity metrics, an ordered presentation of the plurality of accommodations of the plurality of images, wherein the ordered presentation is ordered by grouping the plurality of images into a plurality of image subsets based at least on the plurality of similarity metrics, and wherein each image subset of the plurality of image subsets corresponds to a space of the one or more spaces. The one or more non-transitory computer readable media for determining and organizing the one or more spaces of the hotel or the rental property corresponding with the plurality of images, the one or more non-transitory computer readable media having the one or more instructions stored thereon that, upon execution by the one or more processors, cause the one or more processors to provide, to an interface system, the ordered presentation for presentation.

In some implementations, the ordered presentation includes at least one of a slide show, at least one video, carousel, gallery, or a combination of one or more images and videos, and wherein the plurality of space types include at least one of a bedroom, a bathroom, a kitchen, a living room, an entryway, a dining area, a laundry room, an office, a balcony, a patio, a garage, a storage area, or one or more outdoor spaces.

### BRIEF DESCRIPTION OF THE DRAWINGS

FIG. 1A is a block diagram of an example of a system, in accordance with some implementations of the present disclosure;

FIG. 1B is an example of room scene groupings implemented by the system 100, in accordance with some implementations of the present disclosure;

FIG. 2 is an example architecture of the scene classifier, in accordance with some implementations of the present disclosure;

FIG. 3A is an example architecture of the space overlap detector, in accordance with some implementations of the present disclosure;

FIG. 3B illustrates the operations of a Siamese network, in accordance with some implementations of the present disclosure;

FIG. 3C are examples of similarity scores generated by the space overlap detector, in accordance with some implementations of the present disclosure;

FIG. 3D are examples of supervised positive image pairs, in accordance with some implementations of the present disclosure;

FIG. 3E are examples of positive image pairs, in accordance with some implementations of the present disclosure;

FIG. 3F are examples of negative image pairs, in accordance with some implementations of the present disclosure;

FIG. 3G is a two-stage training process including pretraining and fine-tuning, in accordance with some implementations of the present disclosure;

FIG. 3H are examples of manually tagged positive image pairs, in accordance with some implementations of the present disclosure;

FIG. 3I is a similarity matrix encoded as a heatmap, in accordance with some implementations of the present disclosure;

FIG. 4A is a flow diagram of the room scene grouping method for processing property images, in accordance with some implementations of the present disclosure;

FIG. 4B is a spectral clustering algorithm implemented in the spectral clustering system, in accordance with some implementations of the present disclosure;

FIG. 4C are example images grouped into bedroom clusters, in accordance with some implementations of the present disclosure;

FIG. 4D is a structured representation of the labeled room clusters, in accordance with some implementations of the present disclosure;

FIG. 5 is a flow diagram of an example of a method for processing, classifying, and grouping images in an image modeling pipeline, in accordance with some implementations of the present disclosure.

### DETAILED DESCRIPTION

Implementations of the present disclosure relate to systems and methods for grouping and classifying images of spaces, such as indoor spaces of an accommodation such as a hotel or vacation rental, by incorporating machine learning techniques to improve the organization and representation of spaces. That is, hotels and vacation rentals, among other property types, can provide various accommodations (e.g., bedrooms, kitchens, bathrooms, living areas, outdoor areas). Systems and methods are described that utilize models, such as encoding models, Siamese networks, and/or clustering models, to classify scenes and group images into subsets corresponding to distinct spaces. These techniques facilitate the identification of overlaps and relationships between images, supporting accurate organization of images into subsets. For example, systems and methods in accordance with the present disclosure can generate pairwise similarity metrics using a detection model and encode these metrics in a similarity matrix for clustering. This approach facilitates the grouping of images by analyzing relationships such as overlaps between images of the same space while distinguishing between images of different spaces within a scene. The classification and grouping process can support efficient and accurate organization of image datasets, even under conditions of inconsistent image quality, lighting, or perspective. Additionally, by leveraging automated scene tagging, pairwise similarity detection, and clustering, the systems and methods described herein can improve the reliability and performance of image grouping processes, facilitating clear and intuitive visualization of property layouts and enhancing space representation.

This disclosure relates to systems and methods for grouping and classifying images of indoor spaces, such as systems and methods for scene classification, space overlap detection, and image subset grouping. Some systems can encounter technical limitations in identifying and organizing images of spaces in properties such as vacation rentals or hotels, where the images can include inconsistencies in perspective, lighting, or content across scenes (e.g., bedrooms, bathrooms, kitchens) and spaces (e.g., Bedroom 1, Bedroom 2). That is, the systems can attempt to manage the complexities of detecting overlaps between images of the same space, differentiating between similar-looking spaces, and grouping images accurately for presentation. Some classification models can rely on scene-level tagging (e.g., room type identification based on object or feature presence) to facilitate organization, but such techniques can result in ambiguities due to shared features across rooms or inconsistencies in image quality. These models can also rely on predefined taxonomies or manual annotations, resulting in increased computational overhead, scalability limitations, and errors in grouping.

Additionally, grouping models can be constrained by technical problems in accurately detecting overlaps between image pairs while distinguishing between images of the same scene but different spaces. That is, methods relying on feature matching or manual annotations can be deficient in handling subtle differences in spatial arrangements, angles, or lighting conditions, particularly for large datasets with diverse images.

Various example systems and methods in accordance with the present disclosure can provide a framework for image grouping and classification based on scene tagging, overlap detection, and clustering techniques to address these technical problems. By using machine-learning (ML) models (e.g., Siamese network, shared neural networks, feature extraction models, and/or image similarity metrics) for pairwise overlap detection and utilizing clustering models to group images into subsets, a system can reduce the reliance on manual annotations or predefined heuristics. That is, in some implementations, the framework allows for classification of images by scene type and grouping into subsets representing distinct spaces within those scenes while maintaining computational efficiency and scalability. The overlap detection process may improve accuracy by using feature extraction and pairwise comparison, and the clustering process organizes images into subsets, providing users with an intuitive representation of the layout of spaces (e.g., bedroom arrangements, bathroom locations, kitchen configurations, or shared spaces).

For example, the systems and methods can cause an encoder model (e.g., first model, convolutional neural networks, domain-specific classifiers, object detection models, and/or feature extractors) to generate a plurality of scenes corresponding with a plurality of images. That is, the encoder model can classify images based at least on tagged objects, identified scene features, and/or broader concepts such as indoor/outdoor classification, seasonal context, or privacy context, in some embodiments. In some implementations, the systems and methods can cause a detection model (e.g., second model, Siamese networks, feature similarity models, neural network-based comparison systems, and/or any machine learning-based detection architecture) to generate a plurality of similarity metrics (e.g., pairwise overlap scores, feature vector comparisons, and/or distance metrics) of a plurality of image pairs. The image pairs can correspond with a plurality of spaces (e.g., Bedroom 1, Bathroom 1, Living Room 1) of the plurality of images corresponding with at least one scene (e.g., bedrooms, bathrooms, kitchen, living room, entryway, dining area, laundry room, office, balcony, patio, garage, storage area, or one or more outdoor spaces) of the plurality of scenes.

Various example systems and methods in accordance provide a framework where images are first processed by an encoder model (or a first model) to classify them into scenes, reducing computational operations for subsequent processing by the detection model. The encoder model (or a second model) can generate subsets of images corresponding to specific scenes (e.g., bedrooms, bathrooms, kitchens), and the detection model can generate pairwise similarity metrics within the subsets. For example, the detection model can analyze images classified as bedrooms without performing similarity computations with images classified as kitchens or bathrooms. Classifying images into scenes before similarity analysis reduces the number of pairwise comparisons performed, improving computational efficiency and maintaining grouping accuracy. Additionally, limiting pairwise similarity analysis to images within the same scene can reduce errors caused by comparing unrelated images, improving spatial and feature-based grouping.

Additionally, the systems and methods can determine a plurality of image subsets of the plurality of spaces of the plurality of images corresponding with the at least one scene of the plurality of scenes. That is, the image subsets can represent distinct spaces within the same scene. For example, the plurality of image subsets can be determined based at least on a grouping (e.g., k-means clustering, hierarchical clustering, and/or spectral clustering) of the plurality of images according to the plurality of similarity metrics. In this example, at least one of the plurality of image subsets corresponds with at least one space of the plurality of spaces. In some implementations, the systems and methods can provide the plurality of image subsets of the plurality of images to an interface system (e.g., vacation rental platforms, hotel system, property listing management systems, image cataloging systems, and/or any space visualization tool). Accordingly, the grouping process improves the accuracy of image classification and organization by leveraging automated scene tagging, pairwise overlap detection, and clustering techniques to differentiate between similar-looking spaces and group images into subsets corresponding to distinct spaces, thereby reducing reliance on manual annotations, enhancing scalability for large datasets, and providing a representation of property layouts that facilitates better user understanding and decision-making.

In some implementations, the systems and methods can update a detection model by generating a plurality of similarity metrics corresponding to pairwise comparisons between a first image and a second image of a plurality of images associated with a scene (e.g., bedrooms, bathrooms, kitchens). That is, the similarity metrics can be computed using a shared neural network within a Siamese network to extract feature vectors for the first image and the second image. The extracted feature vectors can then be processed using a vector function (e.g., pairwise addition, element-wise multiplication) to produce a combined feature vector, which can be transformed using a dense layer to generate an intermediate score. Further, an activation function can be applied to generate a pairwise overlap score.

In some implementations, the similarity metrics can be encoded within a similarity matrix, where each element of the matrix can correspond to the pairwise overlap score (e.g., a value representing similarity) between two images. The similarity matrix can be represented as a heatmap (e.g., using a color gradient) to visualize the similarity between image pairs. This representation can be used in clustering functions (e.g., k-means, spectral clustering, hierarchical clustering, and/or any model-based clustering algorithm) to group images into subsets corresponding to distinct spaces (e.g., Bedroom 1, Bedroom 2, Bathroom 1).

Additionally, the systems and methods can classify images by tagging one or more objects within an image, determining scene characteristics, and/or identifying features (e.g., detecting a bed, sink, or table). For example, the system can classify images into scenes such as bedrooms, bathrooms, kitchens, living rooms, entryways, or patios. The classified images can then be grouped into subsets representing spaces based on clustering models applied to the similarity metrics, where each subset can correspond to a specific space (e.g., Bedroom 1).

In some implementations, the detection model can be updated (e.g., trained and/or fine-tuned) using annotated positive image pairs, self-supervised positive image pairs, and/or negative image pairs. For example, annotated positive image pairs can be labeled based on overlap between images of the same space (e.g., Bedroom 1). In another example, self-supervised positive image pairs can be generated by applying transformations (e.g., cropping, rotation, scaling, flipping, and/or synthetic augmentation) to at least one image. In yet another example, negative image pairs can be generated by comparing images from different spaces (e.g., Bedroom 1 and Bedroom 2) within the same scene.

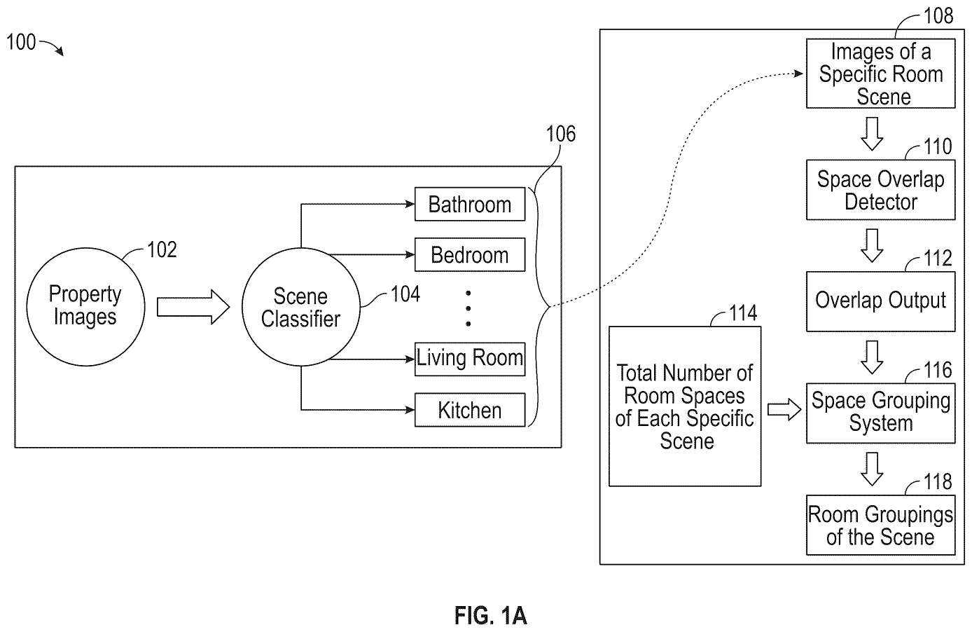

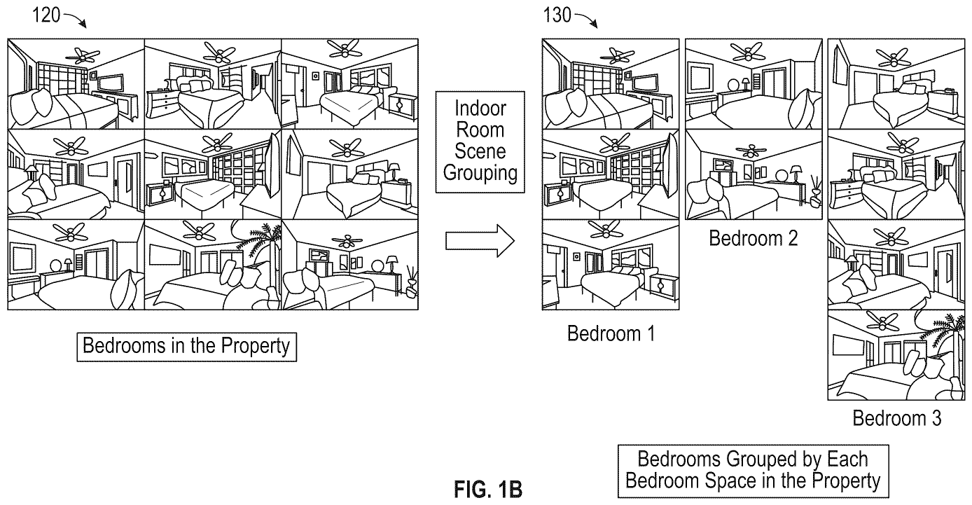

With reference to FIG. 1A, FIG. 1A is an example block diagram of a system 100, in accordance with some implementations of the present disclosure. This and other arrangements are provided as examples, and other configurations (e.g., machines, interfaces, functions, orders, or groupings) can be used, with some elements omitted or combined. Many elements described herein are functional entities and can be implemented as discrete or distributed components in any combination or location. Functions described can be performed by hardware, firmware, and/or software, such as a processor executing instructions stored in memory.

In some implementations, system 100 can include a combination of software and hardware, such as one or more processors and/or processing circuitry configured to execute one or more instructions. System 100 is shown to include various components including the scene classifier 104, the space overlap detector 110, and the space grouping system 116. The system 100 and components can include (e.g., shared or individually) processing circuit including processor(s) and memory. Memory can include instructions stored thereon that, when executed by processor, cause processing circuit to perform the various operations described herein. The operations described herein can be implemented using software, hardware, or a combination thereof. Processor can include a microprocessor, ASIC, FPGA, etc., or combinations thereof. In many implementations, processor can be a multi-core processor or an array of processors. Memory can include, but is not limited to, electronic, optical, magnetic, or any other storage devices capable of providing processor with program instructions. Memory can include a floppy disk, CD-ROM, DVD, magnetic disk, memory chip, ROM, RAM, EEPROM, EPROM, flash memory, optical media, and/or any other suitable memory from which processor can read instructions. The instructions can include code from any suitable computer programming language.

The system 100 can implement at least a portion of an image modeling pipeline, such as a scene classification pipeline and/or an image grouping pipeline. For example, the system 100 can process, classify, and group images of spaces within scenes into subsets corresponding to distinct spaces. The system 100 can be used to organize and analyze property images by any of various systems described herein, including but not limited to, property management systems, vacation rental listing systems, content organization systems, image cataloging systems, visualization systems, and/or search systems.

Generally, the image modeling pipeline can include operations performed by the system 100. For example, the image modeling pipeline can include any one or more of an encoding stage, a detection stage, a grouping stage. Each stage of the image modeling pipeline includes one or more components of the system 100 that perform the functions described herein. In some implementations, one or more of the stages can be performed during the training of artificial intelligence (AI) and/or machine-learning (ML) models. Additionally, one or more of the stages can be performed during the inference phase using the AI or ML models.

In some implementations, the encoding stage can be the stage in the image modeling pipeline in which the system 100 can process property images through a shared neural network architecture to classify scenes, detect features, and/or generate tags corresponding to the images. The system 100 can include at least one scene classifier 104. The scene classifier 104 can include any one or more AI or ML models (e.g., a shared neural network architecture coupled with multiple task-specific heads for tagging, scene classification, and concept identification), rules, heuristics, algorithms, functions, or various combinations thereof to perform operations including causing an encoder model to identify at least one scene of the plurality of scenes 106 for each (e.g., at least one) image of the plurality of images. That is, the scene classifier 104 can identify, using an encoder model, at least one space type of a plurality of space types for each image of the plurality of images of a plurality of accommodations (e.g., bedrooms, bathrooms, kitchens, outdoor spaces or areas) of the hotel or the rental property. For example, the encoder model can be a neural network trained to process property images through a shared neural network architecture (e.g., convolutional neural network (CNN), vision transformer (ViT), or ResNet) to extract feature embeddings and output results via separate heads. In some implementations, the encoder model of the scene classifier 104 can output results from a tag head, scene head, and concept head (e.g., tags, scenes, concepts, and/or any feature descriptors). For example, the property images 102 can be processed by the shared neural network architecture to output tags corresponding to detected objects such as beds, sinks, or tables from the tag head. In another example, the property images 102 can be processed by the scene head to output scenes 106 corresponding to bedrooms, bathrooms, kitchen, living room, entryway, dining area, laundry room, office, balcony, patio, garage, storage area, or one or more outdoor spaces, and/or other spaces. In yet another example, the property images 102 can be processed by the concept head to output features (or concepts) corresponding to indoor/outdoor classification, seasonal context (e.g., summer, winter), or privacy context (e.g., private space, shared space). In some implementations, the property images 102 can be provided to the scene classifier 104 to perform multi-task processing for classification, tagging, and feature extraction using the shared neural network architecture and task-specific heads.

Generally, the scene classifier 104 can identify (or classify), using an encoder model, at least one space type of a plurality of space types for each image of the plurality of images of a plurality of accommodations of the hotel or the rental property. That is, identifying can include the scene classifier 104 analyzing objects, features, and broader concepts (e.g., indoor/outdoor classification, seasonal context, privacy context) within each image to classify the corresponding space type. For example, the encoder model can be executed to extract feature embeddings from each image and classify the image based on detected objects, scene characteristics, or spatial layouts. A space type can be associated with a functional or design category of an accommodation. For example, the space type can be a bedroom, bathroom, kitchen, living room, outdoor space, storage area, and/or any other distinct area within the property. In some implementations, each image of the plurality of images can be classified into one or more space types based on tagged objects and identified features. That is, the plurality of accommodations can be individual rooms, shared spaces, outdoor areas, storage facilities, and/or any other property areas. For example, the scene classifier 104 can analyze spatial features and tagged objects to determine the probable space type for each image and assign corresponding labels for downstream processing.

In some implementations, the machine-learning model(s) can include any type of neural network-based machine-learning models capable of processing image data to classify scenes, generate tags, and identify features (e.g., shared neural networks, convolutional neural networks (CNNs), or vision transformers (ViTs)) to analyze property images and output classifications or features (e.g., categorized and/or classified into scenes 106). For example, the machine-learning model(s) can be trained and/or updated to detect objects or assign images to specific scenes 106, among other classification or feature detection tasks. The machine-learning model(s) can be or include a transformer-based model (e.g., a generative pre-trained transformer (GPT) model). The machine-learning model(s) can be or include a visual encoder model, in some implementations. The scene classifier 104 can execute the machine-learning model to generate outputs (e.g., classifying images by scenes 106). The scene classifier 104 can receive data to provide as input to the machine-learning model(s), which can include property images (e.g., from vacation rental platforms, property management systems, image repositories, and/or user-uploaded datasets). The output can include at least a classification of the property images 102 into scenes 106. That is, the encoder model can process input images to assign scene classifications. For example, a single property image can be assigned to a scene classification (e.g., scenes 106) such as “Bedroom” or “Bathroom” based on detected objects within the image. In this example, the property images 102 can be classified into scenes 106 corresponding to specific spaces.

The scene classifier 104 can include at least one neural network (e.g., visual encoder model). The encoder model can include an input layer, an output layer, and/or one or more intermediate layers, such as hidden layers, which can each have respective nodes. That is, the encoder model can process images through multiple layers to extract features, generate embeddings, and classify the images into scenes. For example, the input layer can receive raw image data or preprocessed image data. For example, the output layer can generate and/or determine (or identify) scene classifications, object tags, features, and/or other metadata based on the input image. For example, the intermediate layers can extract hierarchical features such as edges, textures, or spatial patterns to inform the final classification.

In some implementations, the system 100 can configure (e.g., train, update, fine-tune, apply transfer learning to) the encoder model by modifying or updating one or more parameters, such as weights and/or biases, of various nodes of the encoder model responsive to evaluating outputs of the encoder model (e.g., generated in response to receiving training examples in a training dataset corresponding with scene classifications, object tags, and/or feature annotations). The encoder model can be or include various neural network models, including models that can operate on or generate data including but not limited to image data, video data, audio data, text data, and/or various combinations thereof.

In some implementations, the encoder model of the scene classifier 104 can be configured (e.g., trained, updated, fine-tuned, having transfer learning performed, etc.) based at least on training data of the at least one training dataset (e.g., image datasets, scene-annotated datasets, object detection datasets, feature extraction datasets). For example, one or more example captured images and/or videos of one or more properties of the training data can be applied (e.g., by the system 100, or in a pre-training process performed by the system 100 or another system) as input to the encoder model to cause the encoder model to generate an estimated output. The estimated output can be evaluated and/or compared with ground truth classifications, object tags, or feature annotations (or reference outputs) of the training data that correspond with the one or more example captured images (e.g., labeled images, annotated videos, synthetic training examples) and/or scene-classified videos of one or more properties (e.g., vacation rentals, hotels, office spaces, and/or any residential or commercial properties), and the encoder model of the scene classifier 104 can be updated based at least on the comparison results and/or optimization metrics. For example, based at least on an output of the encoder model, one or more parameters (e.g., weights and/or biases) of the encoder model of the scene classifier 104 can be updated.

In some implementations, the scene classifier 104 can determine a sub-space of at least one image of the plurality of images based at least on the one or more objects and the one or more features. That is, a sub-space can be a portion of a space corresponding to a distinct functional or design-specific area, such as a walk-in closet within a bedroom, a bathroom within a master bedroom, or a seating area within a living room. For example, the sub-space can represent areas identified by clusters of objects and features (e.g., a bed and surrounding furniture) or by spatial boundaries inferred from the arrangement of features. Determining the sub-space can include associating detected objects and features with predefined sub-space categories based on contextual relationships. For example, a sub-space can be determined by identifying a grouping of features (e.g., a bed and a nightstand) that represent a sleeping area within a bedroom. In another example, a sub-space can be determined by detecting structural elements (e.g., doorways or partitions) that delineate a walk-in closet within a larger room.

In some implementations, the detection stage can be the stage in the image modeling pipeline in which the system 100 can process image pairs to detect spatial overlaps and similarities between spaces. The system 100 can include at least one space overlap detector 110. The space overlap detector 110 can include any one or more AI or ML models (e.g., shared neural networks, Siamese network architecture including a plurality of CNNs, or feature comparison models), rules, heuristics, algorithms, functions, or various combinations thereof to perform operations including causing a detection model to generate a plurality of similarity metrics of a plurality of image pairs corresponding with a plurality of spaces of at least one of the plurality of scenes. That is, the detection model can be a Siamese network including a plurality of neural networks trained to process property images through a shared neural network architecture (e.g., convolutional neural network (CNN), vision transformer (ViT), or ResNet) to extract feature embeddings and output pairwise similarity scores (e.g., overlap output 112). In some implementations, the detection model of the space overlap detector 110 can generate similarity metrics (e.g., pairwise overlap scores, similarity matrices, heatmaps, and/or any relationship metrics). For example, the images 108 of a specific room scene can be processed by a Siamese network to generate a similarity matrix representing pairwise relationships. In another example, the images 108 of a specific room scene can be processed by a shared CNN architecture to extract and compare feature embeddings for overlap detection. In some implementations, the images 108 can be provided to the space overlap detector 110 to generate similarity metrics using a dense layer and activation function.

In some implementations, the system 100 can implement a unified model architecture that uses the encoder model and the detection model into a single integrated model for performing both scene classification and overlap detection. The unified model can include a shared neural network backbone (e.g., CNN, ViT, or ResNet) trained to process property images to extract feature embeddings that are used for both classification and similarity detection computations. For example, the shared backbone can output feature embeddings that are simultaneously processed by a scene classification head to classify spaces (e.g., bedroom, bathroom, living room) and a similarity detection head to compute pairwise overlap scores for image pairs. In another example, the unified model can implement multi-task learning, where a single neural network can be trained to minimize (or reduce) losses for both scene classification and pairwise similarity detection objectives.

In some implementations, the space overlap detector 110 can maintain, execute, train, and/or update one or more machine-learning models during the detection stage. In some implementations, the machine-learning model(s) can include any type of neural network-based machine-learning models capable of extracting feature vectors and computing similarity metrics (e.g., Siamese networks, shared CNN architectures, and/or feature comparison models) to analyze image pairs and determine pairwise overlaps. For example, the machine-learning model(s) can be trained and/or updated to generate a plurality of similarity metrics of a plurality of image pairs corresponding with a plurality of spaces of at least one of the plurality of scenes, among other image analysis operations. The machine-learning model(s) can be or include a transformer-based model (e.g., a generative pre-trained transformer (GPT) model). The machine-learning model(s) can be or include a plurality of convolutional neural network (CNNs) within a Siamese network architecture, shared encoder-decoder architecture, and/or any pairwise comparison architecture, in some implementations. The space overlap detector 110 can execute the machine-learning model to generate outputs (e.g., similarity scores and/or overlap predictions of images 108 to corresponding similarity matrices included in an output 112). The space overlap detector 110 can receive data to provide as input to the machine-learning model(s), which can include images of specific room scenes (e.g., such as bedrooms from vacation rental platforms, property management systems, content databases, and/or user-uploaded datasets), preprocessed embeddings, metadata, and/or any images classified by the scene classifier 104. The output can include at least similarity metrics of the images 108 corresponding to detected overlaps or spatial relationships between image pairs. That is, the detection model can analyze feature embeddings from the image pairs and generate overlap scores based on pairwise similarity. For example, a similarity matrix can be encoded as a heatmap to visually represent pairwise overlap scores for clustering purposes. In this example, the images 108 (e.g., of a scene) can be processed to extract feature embeddings, and the output 112 can include similarity scores or matrices for grouping into subsets.

The space overlap detector 110 can include at least one neural network (e.g., CNN). For example, the detection model can include two CNNs configured to extract (e.g., using a shared neural network of the detection model and/or separate neural networks) one or more feature vectors of a first image and a second image (e.g., image pairs of the images 108 of a specific scene). The detection model can combine the one or more feature vectors to output a combined feature vector. For example, the detection model can perform the combining by using a vector function (e.g., element-wise multiplication, addition, concatenation, and/or subtraction) corresponding to a pairwise processing of one or more components (e.g., spatial features, object embeddings) of the one or more feature vectors.

That is, the vector function can be implemented as an element-wise multiplication, addition, concatenation, or subtraction operation applied to corresponding components of the first feature vector and the second feature vector to generate a combined feature vector that preserves spatial and semantic correspondence between the feature vectors. For example, the detection model executed by the space overlap detector 110 can apply element-wise multiplication (e.g., if the first feature vector is [0.2, 0.8, 0.5] and the second feature vector is [0.4, 0.5, 0.9], the element-wise multiplication produces [0.08, 0.40, 0.45], where higher resulting values such as 0.45 indicate strong co-activation of a feature in both images) to emphasize shared feature activations between the first feature vector and the second feature vector. In another example, the vector function can concatenate the first feature vector and the second feature vector (e.g., if the first feature vector is [0.2, 0.8, 0.5] and the second feature vector is [0.4, 0.5, 0.9], the concatenation produces [0.2, 0.8, 0.5, 0.4, 0.5, 0.9], retaining all six components for subsequent processing) to retain all extracted features for subsequent processing. The pairwise processing can apply the selected vector function to the feature vectors in a consistent dimensional alignment to produce a unified representation suitable for transformation by the dense layer.

In some implementations, the detection model can transform the combined feature vector using a dense layer (e.g., fully connected layer, linear transformation layer) to generate an intermediate score. That is, the intermediate score can represent a numerical similarity measure between the processed images. Additionally, the detection model of the space overlap detector 110 can apply an activation function (e.g., sigmoid, ReLU, softmax) to output one or more pairwise overlap scores (e.g., output 112).

The CNNs of the detection model can include an input layer, an output layer, and/or one or more intermediate layers, such as hidden layers, which can each have respective nodes. That is, a CNN can extract feature embeddings from input images, which can be processed by subsequent components of the Siamese network for similarity analysis. For example, the input layer can receive raw image data (e.g., pixel values) from each image in a pair and preprocess it to generate initial feature maps. The intermediate layers can extract hierarchical features, such as edges, textures, spatial patterns, and object layouts, contributing to the representation of each image. The output of each CNN generates a feature embedding, such as h₁ for the first image and h₂ for the second image, where each embedding can be a high-dimensional vector representing the spatial and object-level features of the respective image. The feature embeddings can be passed to a merging function and/or concatenation layer to determine a combined representation z. The merging function can include operations such as element-wise multiplication, addition, and/or concatenation, allowing the space overlap detector 110 implementing the Siamese network to capture relationships between the feature embeddings of the image pair. For example, the merging function can compute z=h₁·h₂ (e.g., element-wise multiplication) or other mathematical operations to output a unified representation of the image pair.

In some implementations, the combined feature vector z can be passed through a dense layer. For example, the dense layer can be used to apply a transformation (e.g., linear, non-linear, weighted projection) to the vector and generates an intermediate score. The intermediate score can capture the overall similarity (e.g., degree of overlap or feature alignment) of the feature embeddings from the two images based on their merged representation. The detection model can be used to apply an activation function, such as a sigmoid function, softmax function, ReLU function, and/or any non-linear transformation function, to the intermediate score to output a pairwise similarity score (e.g., output 112). That is, the score can represent a likelihood of overlap or similarity between the two images.

Additionally, the plurality of similarity metrics can be encoded within a similarity matrix. For example, the similarity matrix can be a two-dimensional (2D) array, and each element of the 2D array can correspond to a similarity metric between a pair of images of the plurality of images. That is, the detection model can generate the similarity matrix by processing pairwise similarity scores for all image pairs of a given scene or space. In some implementations, the similarity matrix can be represented as a heatmap (e.g., color-coded gradients, intensity maps) and/or graph representations (e.g., nodes representing images and edges representing similarity scores). For example, the heatmap can include degrees of similarity between the plurality of image pairs using a color gradient. In this example, the pairwise similarity scores can be encoded in output 112 such that each score visually represents the strength of similarity or overlap between the corresponding image pair, facilitating further clustering or grouping processes.

In some implementations, the system 100 can configure (e.g., train, update, fine tune, apply transfer learning to) the CNNs of the detection model by modifying or updating one or more parameters, such as weights and/or biases, of various nodes of the CNNs responsive to evaluating outputs of the CNN and/or detection model (e.g., generated in response to receiving training examples in a training dataset corresponding with pairwise similarity scores, overlap detections, or classifications of image pairs). The encoder model can be or include various neural network models, including models that can be capable of operating on or generating data including but not limited to similarity metrics, matrices, feature embeddings, heatmaps, and/or various combinations thereof.

In some implementations, the CNNs of the detection model of the scene classifier 104 can be configured (e.g., trained, updated, fine-tuned, has transfer learning performed, etc.) based at least on training data of the at least one training dataset (e.g., labeled image pairs, annotated similarity scores, synthetic image data, augmented datasets). For example, one or more example captured images and/or videos of one or more properties of the training data can be applied (e.g., by the system 100, or in a pre-training process performed by the system 100 or another system) as input to the detection model (e.g., one or more of the CNNs) to cause the detection model to generate an output 112. The output can be evaluated and/or compared with ground truth similarity scores (or labeled overlap data) of the training data that correspond with the one or more example captured images (e.g., training pairs, preprocessed feature embeddings, augmented images) and/or synthetic training videos of one or more properties (e.g., vacation rentals, hotels, residential homes, office spaces, and/or any commercial properties), and the CNNs of the detection model can be updated based at least on the difference between the output and ground truth and/or optimization criteria such as loss functions or accuracy thresholds. For example, based at least on an output of the detection model, one or more parameters (e.g., weights and/or biases) of CNNs of the detection model can be updated.

In some implementations, the CNNs of the detection model can be pre-trained using self-supervised positive image pairs and host-provided negative image pairs. Self-supervised positive image pairs can be generated by applying one or more transformations (e.g., cropping, rotation, scaling, color space adjustments) to a single image of a property. That is, the self-supervised positive image pairs can be generated by applying one or more transformations including at least one of cropping, rotation, scaling, or color space adjusting to one or more images of the plurality of images. For example, the space overlap detector 110 can generate augmented views of an original image using these transformations. In this example, an original image can be paired with its augmented version (e.g., rotated image, cropped image) to simulate a positive pair. In another example, host-provided negative image pairs can be generated by pairing an image of a specific room with another image from a different room space but within the same room type. That is, the negative image pairs can be generated by determining a first image of a first space within the at least one scene and a second image of a second space within the at least one scene. For example, a negative image pair can include two bathrooms with similar wall textures or two bedrooms with similar furniture arrangements. The training pairs can be processed by the CNNs to extract feature embeddings during pretraining.

In some implementations, the CNNs of the detection model can be fine-tuned using manually annotated positive pairs, self-supervised positive pairs, and/or host-provided negative pairs. Manually annotated positive pairs can be labeled by human annotators to identify image pairs with overlapping views of the same space. For example, an annotated positive pair can include two images of a bedroom captured from different angles. That is, the annotated positive image pairs can be generated by determining overlap (e.g., object alignment, spatial consistency) between one or more views and/or angles of a same space of the plurality of spaces. The self-supervised positive pairs and host-provided negative pairs can be generated using the same transformations and pairing techniques as used in the pretraining stage. The fine-tuning process can include processing the pairs through the CNNs to refine the feature embeddings and improve detection model performance.

In some implementations, the detection model can be updated using annotated positive image pairs. Updating can include the system 100 adjusting one or more trainable parameters of the detection model by performing backpropagation using a loss function computed from the difference between predicted similarity scores and ground truth labels for the annotated positive image pairs. Generally, an annotated positive image pair can be obtained by identifying two or more images that depict overlapping views of the same physical space based on manual human annotation or verified metadata and/or selecting such image pairs from a curated dataset of labeled property images. That is, the system 100 can use the annotated positive image pairs as supervised training examples to reinforce the ability of the model to assign high similarity scores to images of the same space. For example, two images of a bedroom captured from different angles but containing the same bed and wall features can be labeled as a positive pair and used to update the weights of the detection model.

In some implementations, the detection model can be updated using self-supervised positive image pairs. Updating can include the system 100 modifying the parameters of the detection model by training on self-supervised positive image pairs generated from transformations of a source image, using a loss function that encourages high similarity scores for such pairs. Generally, a self-supervised positive image pair can be obtained by applying one or more geometric or photometric transformations to an original image to produce a second image that retains the same underlying spatial content and/or pairing the transformed image with the original image as a positive training example. That is, the system 100 can generate such pairs without manual labeling, facilitating large-scale pretraining. For example, an original kitchen image can be rotated and cropped to create a second view, and the pair can be used to train the detection model to recognize them as depicting the same space.

In some implementations, the detection model can be updated using self-supervised negative image pairs. Updating can include the system 100 adjusting the parameters of the detection model by training on negative image pairs to reduce similarity scores for images depicting different spaces within the same scene category. Generally, a negative image pair can be obtained by selecting two images from different physical spaces that share the same scene classification label and/or pairing such images from a dataset where space-level metadata is available. That is, the system 100 can use these negative pairs to penalize false positives in similarity scoring. For example, two different bedrooms in the same property can be paired as a negative example to teach the model to distinguish between similar-looking but distinct spaces.

In some implementations, the CNNs of the detection model can process the images of each room scene to determine and/or calculate pairwise overlap scores for pairs of images. For example, the CNNs can extract feature embeddings for each image pair, which can be processed through a merging function (e.g., element-wise multiplication, addition, concatenation) to generate a combined representation. In another example, the combined representation can be processed through a dense layer to generate intermediate scores, which can be transformed by an activation function (e.g., sigmoid, ReLU) to generate pairwise overlap scores. Additionally, the overlap scores can be encoded in a similarity matrix representing relationships between image pairs.

In some implementations, the similarity matrix can be represented as a heatmap (e.g., color gradients, intensity maps) to visualize the pairwise overlap scores for clustering or grouping purposes. For example, the heatmap can represent degrees of similarity between images using a color gradient (e.g., where brighter colors indicate higher similarity scores). In another example, the similarity matrix can include elements corresponding to pairwise overlap scores for images of a specific room scene (e.g., bedrooms, outside areas). The similarity matrix and heatmap can be used as inputs to a clustering function and/or model (space grouping system 116 implementing, for example, k-means, spectral clustering, hierarchical clustering, and/or any unsupervised machine learning model) to group images into subsets representing distinct spaces.

Generally, the clustering function can be applied by the system 100 to the similarity matrix to partition the set of images into discrete subsets, where at least one (e.g., each) subset corresponds to a distinct physical space within the same scene classification. That is, the clustering function can represent an unsupervised learning algorithm such as spectral clustering, k-means, hierarchical clustering, and/or density-based clustering that uses the similarity metrics as input to determine grouping boundaries. The system 100 can select the clustering algorithm and parameters based on the number of spaces detected for the scene and the distribution of similarity scores. For example, the clustering function can apply spectral clustering to the similarity matrix to identify clusters of images with high intra-cluster similarity and low inter-cluster similarity. In this example, each resulting cluster corresponds to a unique space, such as Bedroom 1 or Bedroom 2.

In some implementations, the grouping stage can be the stage in the image modeling pipeline in which the system 100 can organize images into subsets corresponding to distinct spaces within a scene. The system 100 can include at least one space grouping system 116. The space grouping system 116 can determine a plurality of image subsets of the plurality of spaces of the plurality of images corresponding with the at least one scene of the plurality of scenes. That is, the plurality of image subsets can be determined based at least on a grouping of the plurality of images according to the plurality of similarity metrics, and at least one of the plurality of image subsets can correspond with at least one space of the plurality of spaces. For example, during the grouping stage, the space grouping system 116 can receive and/or otherwise identify outputs 112 (e.g., from the space overlap detector 110) and a space count 114 (e.g., 3 bedrooms) of at least one scene (e.g., bedrooms) of the plurality of scenes. In this example, the room groupings 118 of the scene can be the output of the space grouping system 116. That is, the room groupings 118 can include grouped subsets of images, where each subset corresponds to a specific space (e.g., Bedroom 1, Bedroom 2, Bedroom 3) and includes the images representing different views of the same space.

In some implementations, the space grouping system 116 can generate an ordered presentation of the plurality of accommodations of the plurality of images using the plurality of similarity metrics. For example, the space grouping system 116 can group images into subsets corresponding to distinct spaces (e.g., accommodations of the hotel or rental property) such as bedrooms, bathrooms, or living rooms based on pairwise similarity scores. That is, the ordered presentation can be ordered by grouping the plurality of images into a plurality of image subsets based at least on the plurality of similarity metrics. The space grouping system 116 can process similarity metrics to identify clusters of images that share overlapping features or spatial relationships. For example, each image subset of the plurality of image subsets corresponds to a space of the one or more spaces. In this example, the subsets can represent specific rooms or areas within a property, such as “Bedroom 1” or “Bathroom 2.” Additionally, the space grouping system 116 can generate and/or provide a structured representation of the property layout (e.g., ordered presentation).

In some implementations, the space grouping system 116 can group images into subsets corresponding to distinct spaces by processing a pairwise overlap score matrix (e.g., output 112) generated for a specific room scene. The pairwise overlap score matrix can be used as input to a spectral clustering model, which can identify clusters of images corresponding to individual spaces within the room scene. For example, spectral clustering can transform the similarity matrix into a lower-dimensional space by computing eigenvectors of the matrix, capturing complex, non-linear relationships among the images. In another example, the clustering algorithm can apply k-means or similar techniques in the transformed space to group the images into subsets representing distinct spaces (e.g., Bedroom 1, Bedroom 2).

In some implementations, the outputs 112 and space count 114 can be used as input to the space grouping system 116. The space grouping system 116 can apply clustering (e.g., spectral clustering, k-means, hierarchical clustering, or DBSCAN) to generate room groupings 118 representing subsets of images corresponding to distinct spaces within a scene (e.g., Bedroom 1, Bedroom 2, Bathroom 1). The room groupings 118 can be provided to an interface system (e.g., vacation rental platforms, property management systems, content visualization tools, recommendation engines, and/or any data-driven interface). That is, the interface system can use the room groupings 118 to organize and present property layouts or enhance search and recommendation functionalities. For example, the provided room groupings 118 can be used by a vacation rental platform to display grouped images of individual spaces, such as bedrooms or kitchens, for improved property visualization by potential renters.

The outputs 112 can represent the determined similarity matrix, pairwise overlap scores, and/or any intermediate representations generated by the detection model for a given set of images within a scene. For example, the outputs 112 can include a two-dimensional array where each element corresponds to the similarity score between a pair of images, optionally visualized as a heatmap. In this example, the outputs 112 serve as the input to the clustering stage for grouping images into subsets. The space count 114 can represent the estimated and/or known number of distinct physical spaces within the scene category being processed. For example, the space count 114 can be determined from property metadata indicating the number of bedrooms or bathrooms. In this example, the space count 114 is used as a parameter for clustering.

In some implementations, the space grouping system 116 can generate and/or provide the room groupings 118 in a structured format (e.g., slide shows, video presentations, carousels, or image galleries). That is, generating a structured format can include arranging the room groupings into categories based on the similarity metrics and organizing the associated images or videos into sequences for presentation. For example, the structured format can include a carousel presentation of room images, with each image subset grouped under its respective space type (e.g., Bedroom 1, Bedroom 2, Bathroom 1). Additionally, the ordered presentation can be generated for presentation including a video compilation displaying sequential transitions between grouped images of a specific room type. In this example, the video can include details of each space, such as furniture arrangements or room layouts, and/or other metadata. In another example, an ordered presentation can be generated for presentation including a slide show of images grouped by room type, with captions indicating the space type and sequence. In this example, the slide show can provide a an overview of the grouped accommodations for user navigation. In some implementations, the at least one image of the plurality of images of the plurality of image subsets can include metadata corresponding to the sub-space. That is, the metadata can be data describing the identified sub-space, such as its type, associated objects, and spatial boundaries. For example, the interface system receiving the image subsets can use the metadata to present structured representations and/or notes or comments of the sub-spaces for user navigation or analysis.

Referring now to FIG. 1B, FIG. 1B illustrates an example of room scene groupings implemented by the system 100, in accordance with some implementations of the present disclosure. In some implementations, the images 120 can correspond to a plurality of bedrooms in a property, with multiple views captured from varying angles and perspectives. The scene classifier 104 can classify the images 120 into scenes (e.g., bedrooms), and the space overlap detector 110 can generate pairwise overlap scores and/or matrices for image pairs. The space grouping system 116 can process these overlap scores to generate room groupings 130. The room groupings 130 can represent subsets of images grouped by individual bedroom spaces (e.g., Bedroom 1, Bedroom 2, Bedroom 3). Each subset can include images that correspond to a distinct bedroom.

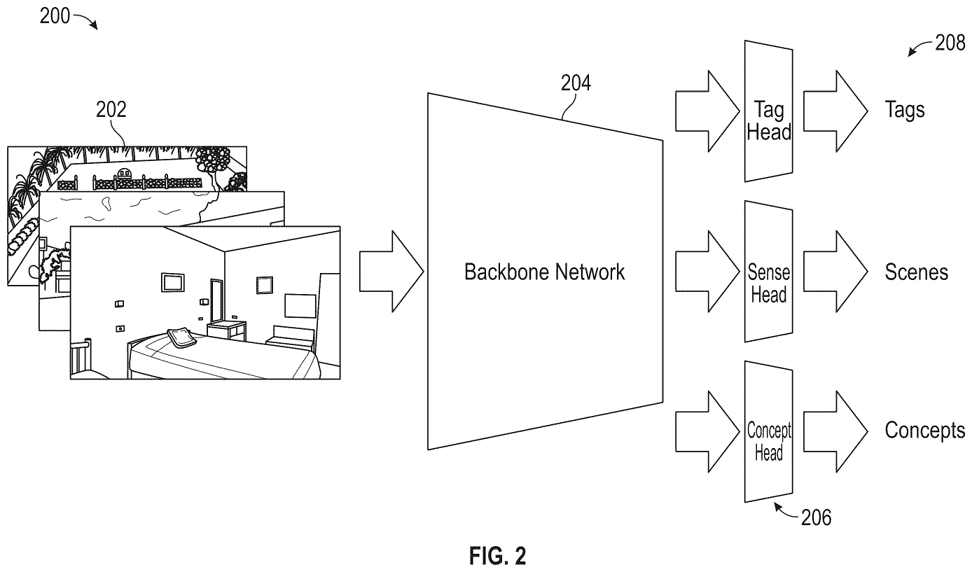

Referring now to FIG. 2, FIG. 2 illustrates an example architecture 200 of the scene classifier 104 of FIG. 1A, in accordance with some implementations of the present disclosure. The scene classifier 104 can process a plurality of property images 202 to generate outputs corresponding to tags, scenes, and concepts (among other outputs and/or classifications, collectively referred to as “outputs 208”). The property images 202 can include multiple images representing different views or areas of a property, such as outdoor views, bedrooms, or kitchens. The images 202 can be processed through a backbone network 204, which can extract feature embeddings representing the content and characteristics of the images. The backbone network 204 can include a shared neural network architecture (e.g., convolutional neural networks (CNNs), vision transformers (ViT), or ResNet models) trained and/or implemented to process the property images 202. The extracted feature embeddings can then be passed to multiple task-specific heads, including, but not limited to, a tag head, a scene head, and a concept head to generate outputs 208 (collectively tags, scenes, and concepts). The tag head can output tags corresponding to detected objects or features in the images, such as beds, sinks, or tables. The scene head can output scenes corresponding to room types, such as bedrooms, bathrooms, or kitchens. The concept head can output broader concepts or characteristics of the images, such as indoor/outdoor classification, seasonal context (e.g., summer, winter), or privacy context (e.g., private space, shared space). That is, the concept head can assign one or more concepts to each image based at least on its content. For example, the concept head can identify whether an image depicts an indoor private space or an outdoor shared area. In some implementations, the concept head can include metadata identifying the concepts, which can be used by downstream systems to customize presentations to specific traveler preferences. In some implementations, the outputs 208 generated by the tag head, scene head, and concept head can provide a classification and/or tagging of the property images 202.

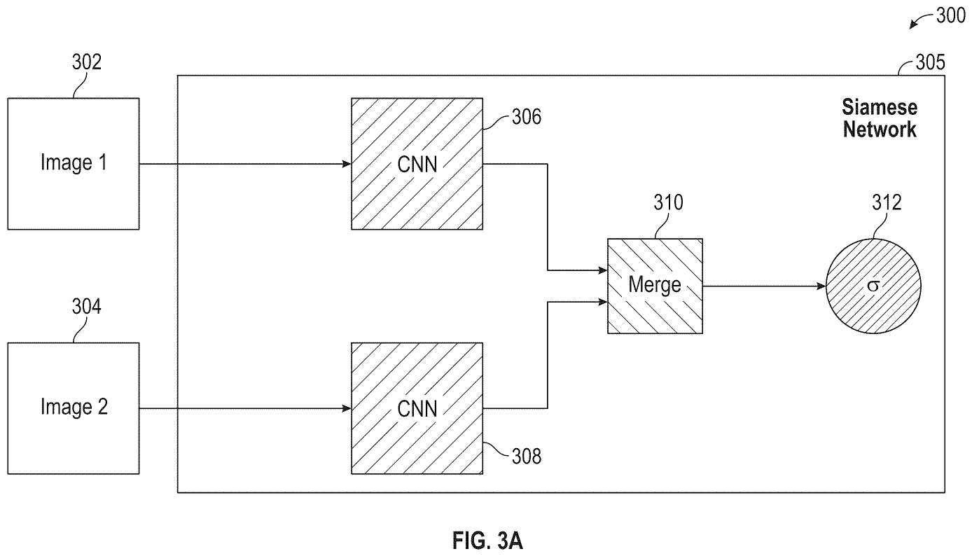

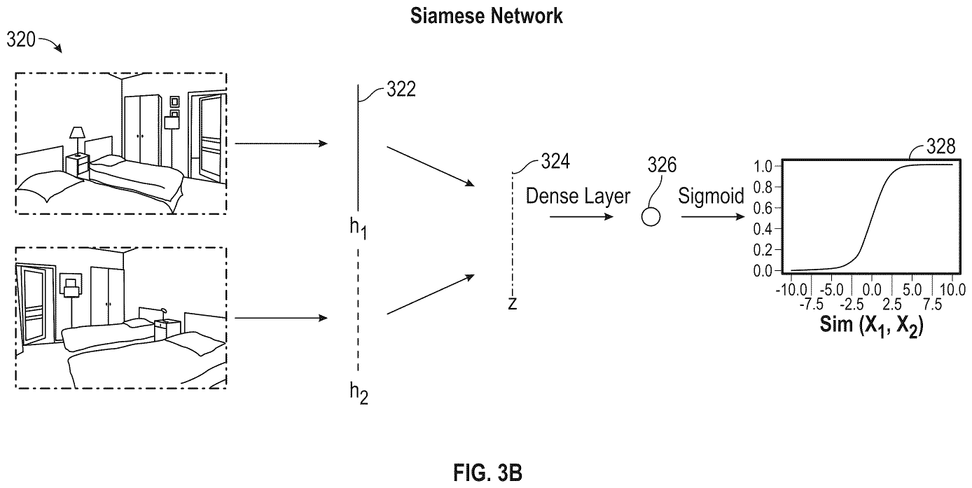

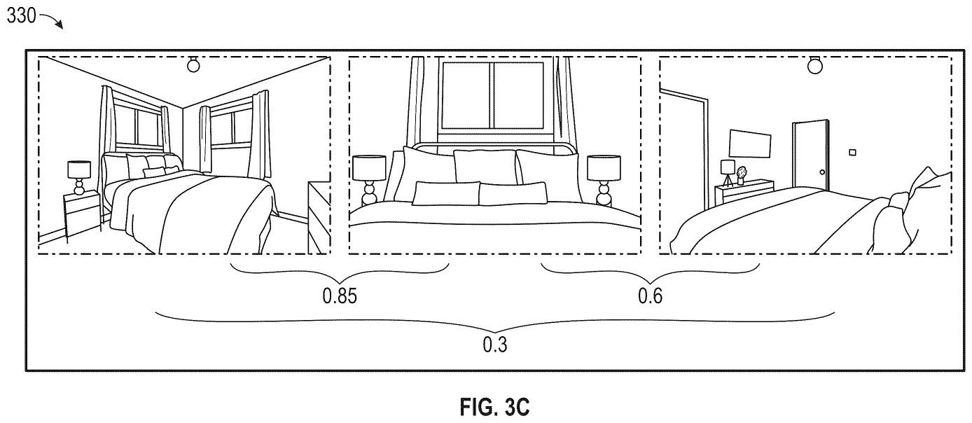

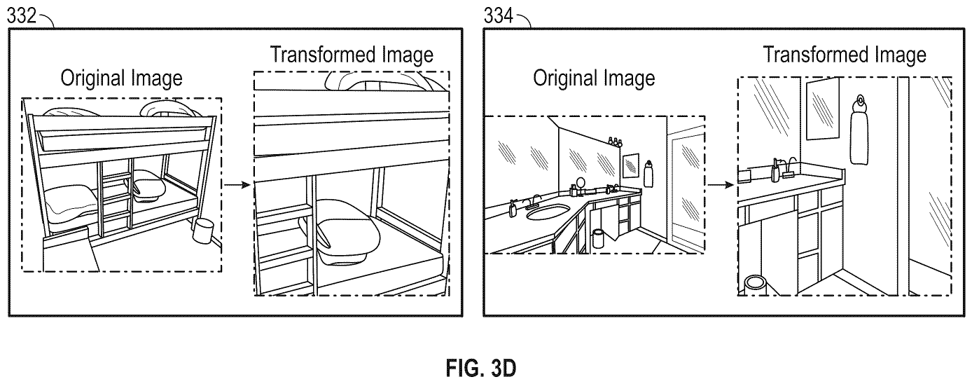

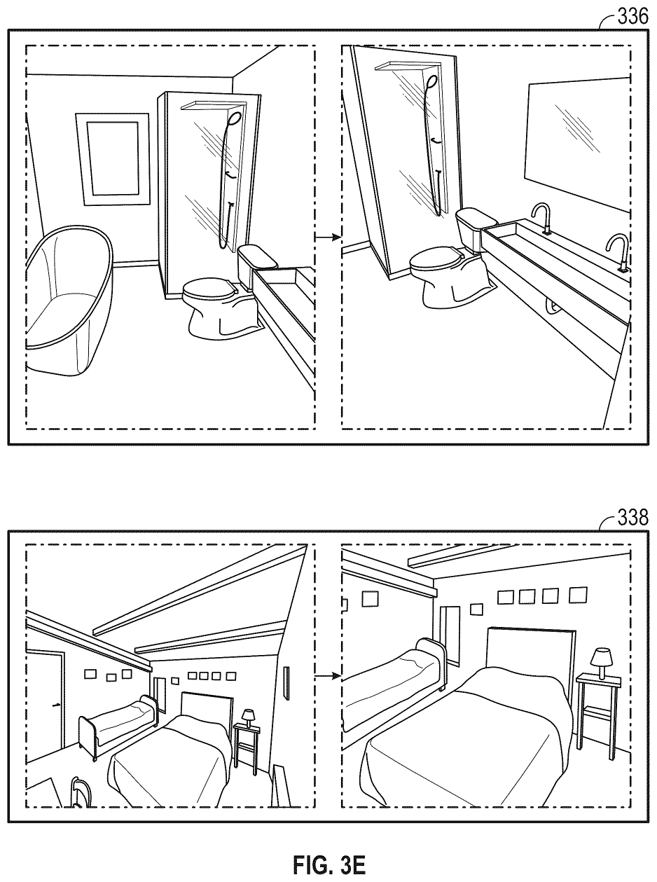

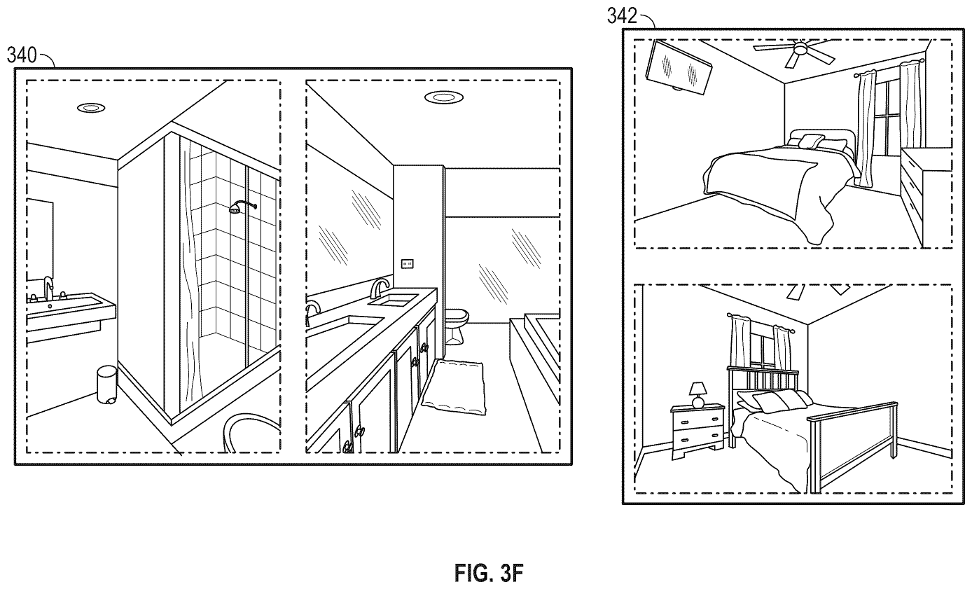

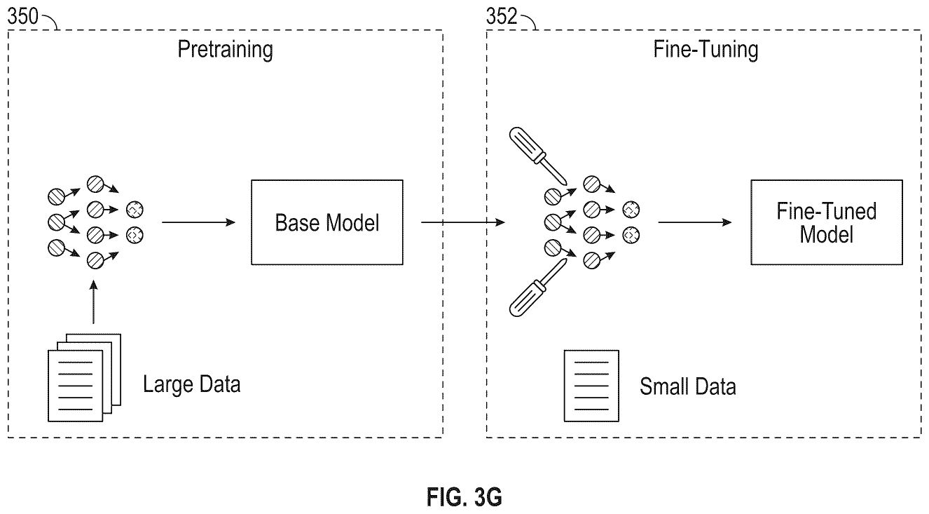

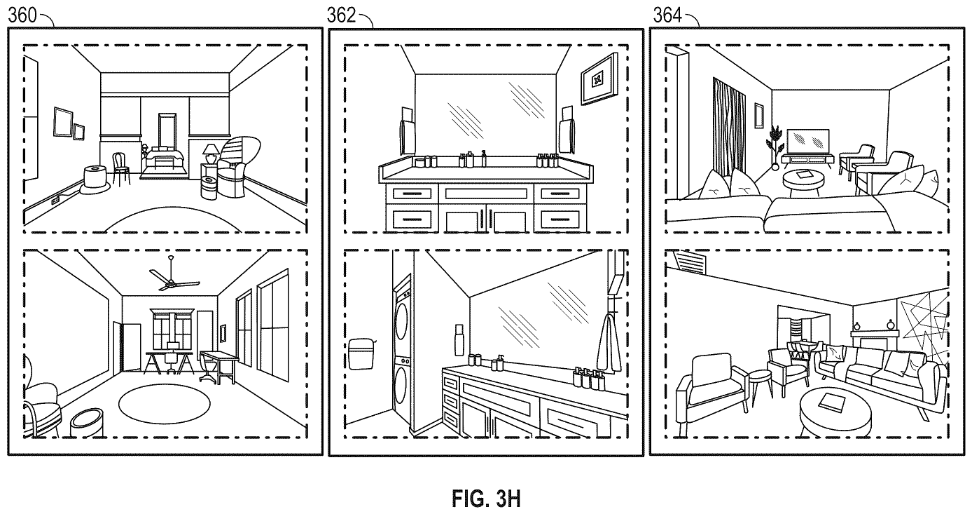

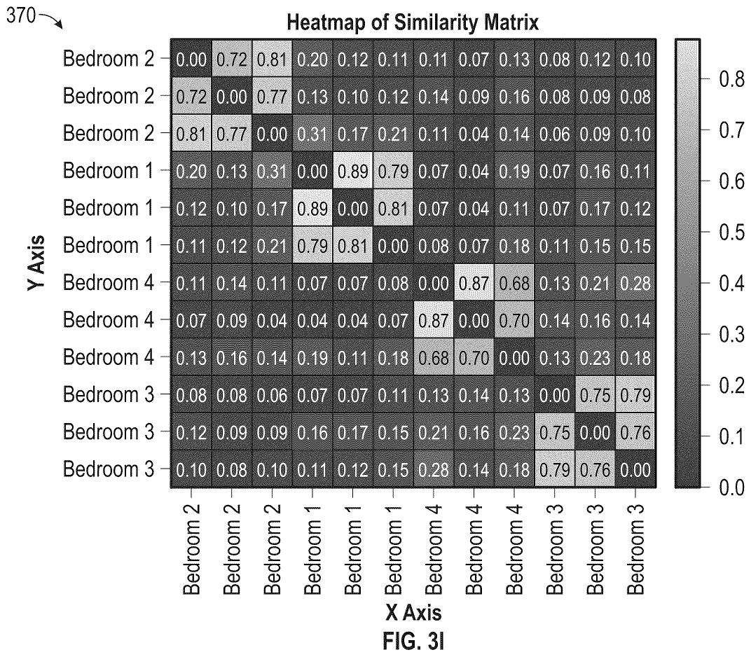

Referring now to FIG. 3A, FIG. 3A illustrates an example architecture 300 of the space overlap detector 110, which implements a Siamese network 305 in accordance with some implementations of the present disclosure. The space overlap detector 110 can process two images (e.g., pairs), such as image 302 and image 304 (e.g., a pair of images from the plurality of images), through parallel CNNs. That is, image 302 can be processed by CNN 306 to extract a feature embedding, and image 304 can be processed by CNN 308 to generate another feature embedding. In some implementations, these CNNs share the same neural network architecture to facilitate consistent feature extraction across image pairs. The feature embeddings extracted from CNN 306 and CNN 308 can be merged using a merging function 310. For example, the merging function 310 can include operations such as element-wise multiplication, addition, or concatenation to combine the feature embeddings into a single representation z. That is, the merging operation can capture the relationships between the features of the two images. The combined representation z can be processed through an activation function 312, such as a sigmoid function, to generate a similarity score. That is, the similarity score can quantify the likelihood of spatial overlap or similarity between the pair of images. For example, a high similarity score can indicate that the images represent overlapping views of the same room, while a low score can indicate that the images correspond to different spaces within the same scene.

Referring now to FIG. 3B, FIG. 3B illustrates the operations of the Siamese network 305 of FIG. 3A, in accordance with some implementations of the present disclosure. The images 320 can represent an input image pair that is processed by the Siamese network 305. Each image can be transformed into feature embeddings at step 322, shown as h₁ for the first image and h₂ for the second image (e.g., using CNNs of a detection model). In some implementations, the embeddings can represent high-dimensional feature vectors that encode spatial, structural, or visual patterns in the respective images. The embeddings h₁ and h₂ can be merged into a combined representation z at step 324 using a merging function. For example, the merging function can perform element-wise multiplication or addition to combine the embeddings to identify shared or distinguishing features. The combined representation z can be passed through a dense layer at step 326 that can apply a transformation to determine an intermediate score. In some implementations, the transformation can include linear and/or nonlinear operations to weight different features within the combined representation. Additionally, the intermediate score can be subsequently processed through a sigmoid activation function at step 328 to output a pairwise similarity score. That is, the similarity score can quantify the spatial relationship between the two images (e.g., such as whether they depict overlapping views of the same room or different spaces).

Generally referring to FIGS. 2, 3A, and 3B, the scene classifier 104 and/or the space overlap detector 110 can operate in sequence within the image processing pipeline to classify property images 202 by scene type and determine spatial similarity between images within the same scene category. The scene classifier 104 can maintain, execute, train, update, and/or otherwise process one or more artificial intelligence models during the encoding stage. The artificial intelligence model(s) can include a visual encoder model implemented as a backbone network 204, which can be a CNN, a ViT, a ResNet, and/or another deep neural network architecture configured to extract high-dimensional feature embeddings from the property images 202. The property images 202 can include multiple images representing different views or areas of a property, such as outdoor views, bedrooms, bathrooms, kitchens, or living rooms. Each image can be processed through the backbone network 204 to produce a feature embedding vector of fixed dimensionality (e.g., 512, 768, or 1024 numerical components). The backbone network 204 can be coupled to multiple task-specific output heads, including a tag head, a scene head, and a concept head. The tag head can output object tags (e.g., bed, sink, table) with associated confidence scores between 0.0 and 1.0. The scene head can output a scene classification label (e.g., bedroom, bathroom, kitchen) with a probability distribution over all possible scene types. The concept head can output higher-level contextual attributes (e.g., indoor/outdoor classification, seasonal context, privacy context) with associated confidence scores. The outputs 208 from the tag head, scene head, and concept head can be stored as metadata and used by downstream components.

Additionally, the space overlap detector 110 can maintain, execute, train, update, and/or otherwise process one or more artificial intelligence models during the detection stage. The artificial intelligence model(s) can include a Siamese network 305 configured to process pairs of images from the same scene category. The space overlap detector 110 can receive as input two images, such as image 302 and image 304, which can be selected from the outputs of the scene classifier 104. Image 302 can be processed by a first convolutional neural network 306, and image 304 can be processed by a second convolutional neural network 308. In some implementations, CNN 306 and CNN 308 share identical architecture and weights to ensure consistent feature extraction. At least one (e.g., each) CNN can output a feature embedding vector (e.g., 512 components) representing spatial and semantic features of the corresponding image. The feature embeddings from CNN 306 and CNN 308 can be combined in a merge function 310 (e.g., merge operation(s)). The merge function 310 can implement a vector function such as element-wise multiplication, addition, concatenation, or subtraction. For example, if the first embedding is [0.2, 0.8, 0.5] and the second embedding is [0.4, 0.5, 0.9], element-wise multiplication produces [0.08, 0.40, 0.45], where higher resulting values indicate stronger co-activation of features in both images. Concatenation of the same vectors produces [0.2, 0.8, 0.5, 0.4, 0.5, 0.9], retaining all extracted features for subsequent processing.

The merged representation z (step 324) can be passed through a dense layer to produce an intermediate score. The dense layer can apply a linear transformation with learned weights and biases to project the combined vector into a scalar or lower-dimensional representation. The intermediate score can then be processed by an activation function (step 326), such as a sigmoid, to output a similarity score (step 328) between 0.0 and 1.0. For example, a similarity score of 0.92 can indicate that image 302 and image 304 depict overlapping views of the same bedroom, while a score of 0.18 can indicate that they depict different bedrooms. The similarity scores for all relevant image pairs can be aggregated into a similarity matrix, which can be used by downstream clustering algorithms to group images into subsets corresponding to distinct spaces. Generally, the scene classifier 104 and space overlap detector 110 can be trained jointly or independently. Training can include supervised learning using annotated datasets containing property images labeled with scene types, object tags, concepts, and space-level overlap annotations. The scene classifier 104 can be trained with cross-entropy loss for scene classification and binary cross-entropy loss for multi-label tagging. The space overlap detector 110 can be trained with binary cross-entropy loss for similarity prediction, using positive pairs (same space) and negative pairs (different spaces) as training examples. Self-supervised positive pairs can be generated by applying transformations such as cropping (e.g., removing 15% of pixels from the top and 10% from the right), scaling (e.g., resizing from 1024×768 to 800×600 pixels), rotation (e.g., +15 degrees), and color space adjustments (e.g., increasing saturation by 20%, reducing brightness by 10%).

Evaluation of the scene classifier 104 can include metrics such as top-1 accuracy, top-5 accuracy, precision, recall, and F1 score for each output head. Evaluation of the space overlap detector 110 can include metrics such as area under the ROC curve (AUC), precision at a fixed recall, and false positive rate at a fixed true positive rate. For example, the space overlap detector 110 may be required to achieve an AUC above 0.95 on a validation set of 20,000 image pairs before deployment. The scene classifier 104 can be pretrained on large-scale general-purpose datasets (e.g., ImageNet, Places365) to learn general visual features, and then fine-tuned on domain-specific datasets containing property images. The space overlap detector 110 can be pretrained using self-supervised learning on unlabeled property images to learn feature similarity, and then fine-tuned using annotated positive and negative pairs. Fine-tuning can involve adjusting all parameters or selectively updating only the merge function 310 and dense layer parameters while freezing CNN 306 and CNN 308. In some implementations, the scene classifier 104 and space overlap detector 110 can be deployed on hardware accelerators such as GPUs or TPUs to process high-resolution images in real time. The models can be optimized using techniques such as mixed-precision training, weight pruning, and quantization to reduce memory footprint and inference latency. The outputs 208 from the scene classifier 104 and the similarity scores (step 328) from the space overlap detector 110 can be stored in a structured format for use by downstream grouping and visualization systems.

Referring now to FIG. 3C, FIG. 3C depicts examples of similarity scores generated by the space overlap detector 110, illustrating differences in pairwise scores for images of the same room space, in accordance with some implementations of the present disclosure. For example, images 330 can depict multiple views of the same bedroom captured from different angles and perspectives. In some implementations, the space overlap detector 110 processes each pair of images to generate pairwise similarity scores, such as 0.85, 0.6, and 0.3, which indicate varying degrees of overlap or similarity between the image pairs. For example, a similarity score of 0.85 can correspond to images with overlapping features, such as shared furniture or visible structural elements, while a score of 0.3 can indicate images with fewer shared visual cues. The variability in scores reflects the ability of the detection model to analyze differences in spatial relationships between image pairs. That is, the scores allow the space grouping system 116 to identify and group images into subsets based on their relative spatial overlap. In some implementations, the pairwise similarity scores are encoded within a similarity matrix or heatmap to facilitate clustering during the grouping stage.

Referring now to FIG. 3D, FIG. 3D illustrates examples of supervised positive image pairs 332, 334 transformed by applying data augmentation techniques to generate variations of the original images, in accordance with some implementations of the present disclosure. In some implementations, data augmentation can include transformations such as cropping, scaling, rotation, and/or color space adjustments. Cropping can include removing 15% of the pixel rows from the top edge and 10% of the pixel columns from the right edge of the original image, resulting in a reduced field of view that still contains the primary objects of interest. Scaling can include resizing an original 1024×768 pixel image to 800×600 pixels while preserving the aspect ratio. Rotating can include rotating the image by +15 degrees around its center point using bilinear interpolation to fill missing pixel values. Color space adjustments can include increasing the saturation channel in the HSV color space by 20% and reducing the brightness value by 10% to simulate different lighting conditions. For example, supervised positive image pair 332 can depict an original image of a bunk bed and its transformed version with adjustments in the image angle and crop. Similarly, supervised positive image pair 334 can depict a bathroom image and its transformed version, where the augmented version emphasizes different regions of the scene. In another example, color space adjustments can convert the original RGB image to grayscale and then remap it back to RGB with altered luminance values to simulate low-light capture conditions. In this example, the color space adjustment modifies the perceived tone and contrast of surfaces such as tiles or bedding while retaining the spatial structure for similarity detection.

Referring now to FIG. 3E, FIG. 3E illustrates positive image pairs 336, 338 generated during the pretraining process to simulate supervised positive pairs, in accordance with some implementations of the present disclosure. In some implementations, pretraining can use self-supervised techniques to generate augmented views of the same image. For example, positive pair 336 depict images of a bathroom where augmentation preserves spatial consistency, and positive pair 338 depict images of a bedroom with variations in angle and framing to simulate realistic scene captures.

Referring now to FIG. 3F, FIG. 3F illustrates negative image pairs 340, 342 used during training to distinguish between images of different spaces within the same room type, in accordance with some implementations of the present disclosure. For example, negative pair 340 includes two bathroom images with similar tile patterns but differing layouts, challenging the detection model to learn nuanced spatial differences. Similarly, negative pair 342 includes bedroom images where furniture arrangements and lighting differ, despite shared elements such as wall color. That is, the negative pairs can be generated and/or provided to refine (or tune) the detection model to differentiate between spaces with similar visual features.

Referring now to FIG. 3G, FIG. 3G illustrates a two-stage training process including pretraining 350 and fine-tuning 352, in accordance with some implementations of the present disclosure. During pretraining 350, a base model can be trained on a large dataset using self-supervised learning techniques. For example, the base model can process self-supervised positive image pairs and host-provided negative image pairs to extract generalizable patterns and representations. The pretraining stage can allow the model to learn feature embeddings without requiring a manually curated dataset. In some implementations, fine-tuning 352 can be used to refine the pre-trained base model into a specialized fine-tuned model (e.g., detection model). In some implementations, this stage incorporates a smaller dataset of manually labeled positive image pairs and previously generated self-supervised and negative image pairs. The fine-tuning process can adjust and/or update the model parameters to address domain-specific tasks while maintaining knowledge acquired during pretraining.

Referring now to FIG. 3H, FIG. 3H illustrates manually tagged positive image pairs 360, 362, and 364, in accordance with some implementations of the present disclosure. In some implementations, the pairs can represent scenarios used during the fine-tuning stage. Image pair 360 includes a living room from differing perspectives, highlighting overlapping elements such as furniture arrangements and spatial layout. Image pair 362 includes two angles of a bathroom depicting a consistent design across images, such as fixtures and wall patterns. Image pair 364 includes examples of a shared family room captured at non-identical angles with partial occlusion. In some implementations, the manually tagged positive pairs can be used to improve the detection model.

Referring now to FIG. 3I, FIG. 3I illustrates a similarity matrix 370 encoded as a heatmap, representing pairwise similarity scores between images of bedrooms labeled Bedroom 1 through Bedroom 4, in accordance with some implementations of the present disclosure. The similarity scores can range from 0.0 to 1.0, where higher values indicate stronger overlap between the features of two images. For example, images within Bedroom 1 have high similarity scores (e.g., 0.89 and 0.81), reflecting consistency in features such as bed arrangements and lighting. In another example, the similarity scores between images of Bedroom 3 and Bedroom 4 are lower (e.g., 0.28), indicating minimal overlap in visual characteristics. In some implementations, the heatmap can include a color gradient to visually differentiate degrees of similarity, where brighter colors indicate higher scores. In some implementations, the similarity matrix 370 can be used as input to clustering algorithms, such as spectral clustering, to group images into distinct room spaces based on their similarity scores.

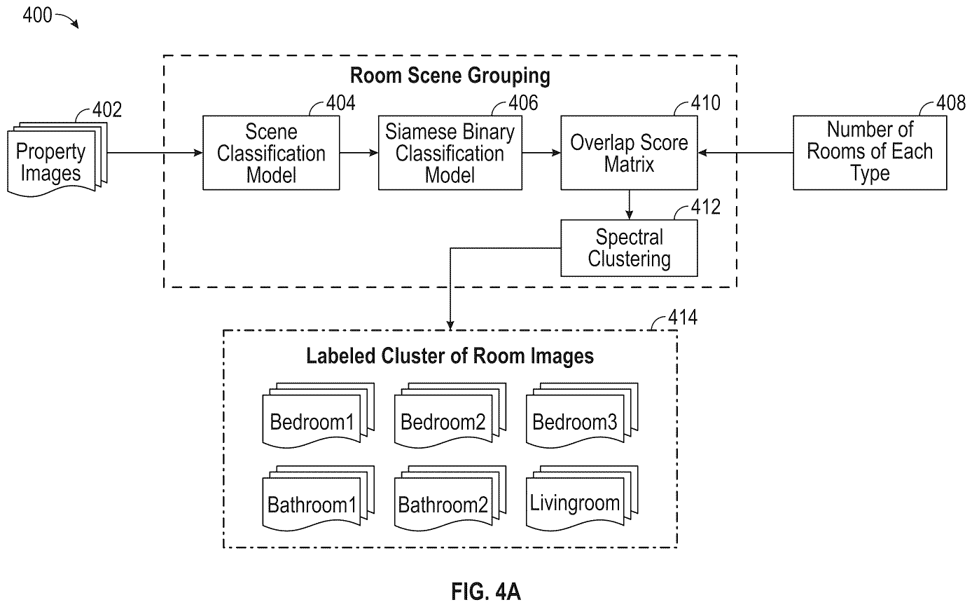

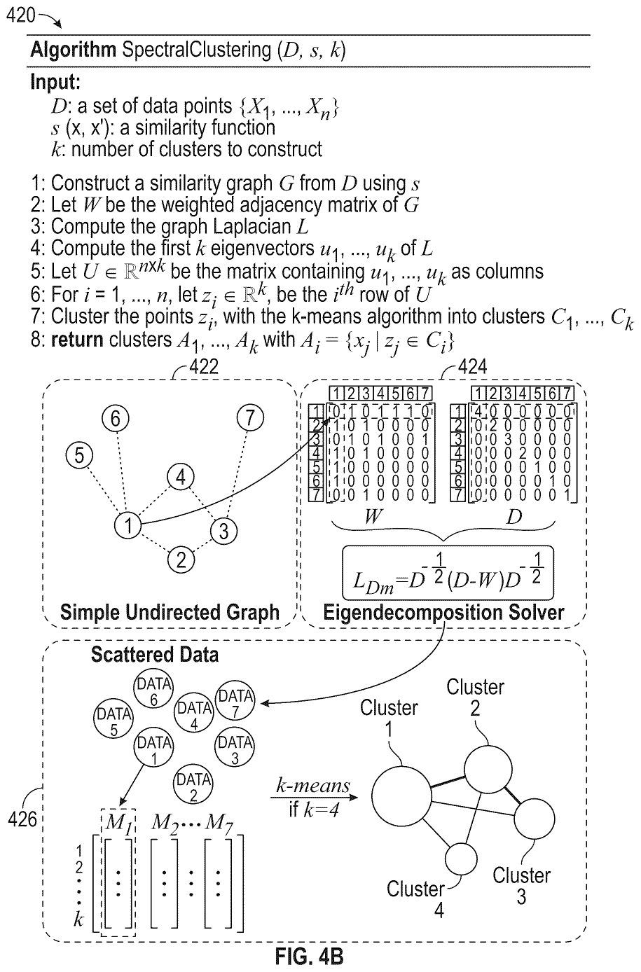

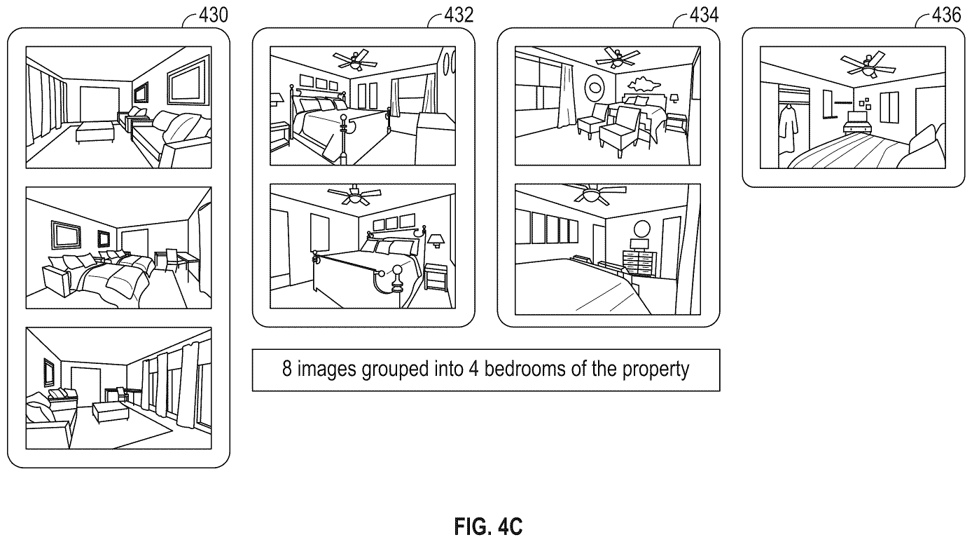

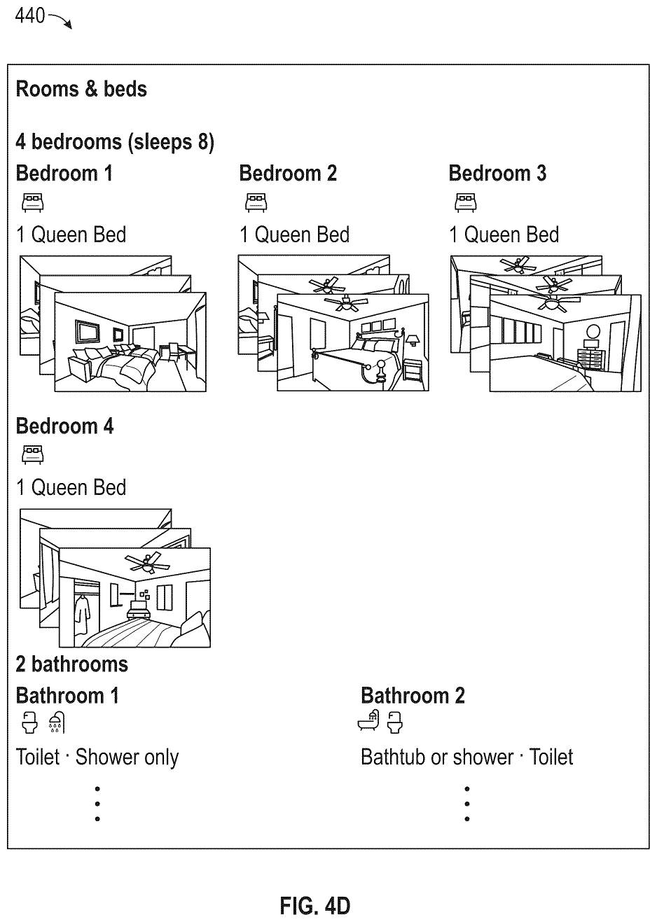

Referring now to FIG. 4A, FIG. 4A depicts a flow diagram of the room scene grouping method 400 for processing property images 402, in accordance with some implementations of the present disclosure. The property images 402 can be processed by a scene classification model 404 (e.g., scene classifier 104 of FIG. 1A) to identify room types such as bedrooms, bathrooms, or living rooms. The outputs of the scene classification model 404 can be passed to a Siamese binary classification model 406 (e.g., space overlap detector 110 of FIG. 1A) implemented to generate an overlap score matrix 410 by comparing pairs of images to compute similarity metrics. A number of rooms of each type 408 can be determined to guide the clustering process.

In some implementations, the overlap score matrix 410 can be provided as input to the spectral clustering system 412 (e.g., space grouping system 116 of FIG. 1A). The spectral clustering system 412 can use the pairwise similarity scores from the overlap score matrix 410 to form clusters of room images. For example, the spectral clustering process can use eigenvectors of the similarity matrix to transform data into a lower-dimensional space. In some implementations, the process identifies room spaces within the same room type (e.g., Bedroom 1, Bedroom 2). Additionally, the output of the spectral clustering system 412 can be represented as labeled clusters 414 of room images. These labeled clusters 414 can correspond to specific room spaces grouped based on their visual and spatial characteristics. For example, Bedroom 1 can include multiple images capturing different perspectives of the same room and Bedroom 2 can include images of a separate bedroom. That is, the labeled clusters 414 can provide a structured organization of property images grouped by room type and individual spaces.

Referring now to FIG. 4B, FIG. 4B illustrates the spectral clustering algorithm 420 implemented in the spectral clustering system 412 of FIG. 4A (e.g., space grouping system 116 of FIG. 1A), in accordance with some implementations of the present disclosure. That is, the spectral clustering can include receiving as input the set of data points D={x₁, . . . , xₙ}, a similarity function s(x, x′), and the desired number of clusters k. In some implementations, step 422 depicts the construction of a similarity graph G from the dataset D using the similarity function s(x, x′). That is, nodes in the graph G can represent data points, and edges can represent similarity values. In some implementations, step 424 depicts the generation of the weighted adjacency matrix W of the similarity graph G can be calculated. The degree matrix D, a diagonal matrix where each diagonal entry Dᵢᵢ can be the sum of the weights of edges connected to node i. The graph Laplacian L can be depicted using the formula L=D−W, capturing the structural relationships within the graph. In some implementations, for normalized spectral clustering, the normalized Laplacian

$${L}_{norm} = {D}^{- \frac{1}{2}} ( D - W ) {D}^{- \frac{1}{2}}$$

can be used in an eigen decomposition process. At step 426, the spectral clustering system 412 can determine first k eigenvectors u₁, . . . uₖ of the graph Laplacian L, corresponding to the k eigenvalues (e.g., smallest). The eigenvectors can be generated and/or assembled into a matrix U∈ [symbol] ^{n*k}, where each row zᵢ can represent a transformed data point in the reduced eigenvector space. The spectral clustering system 412 can apply a clustering method, such as k-means, to the rows zᵢ of U to partition the data into k clusters. As shown, the output can include clusters A₁, . . . Aₖ where each cluster Aᵢ={xⱼ|zⱼ∈Cᵢ} contains the data points xⱼ whose transformed representations zⱼ belong to cluster Cᵢ (e.g., representing the grouping results used to cluster the room images into labeled subsets, as shown in FIG. 4A).

Referring now to FIG. 4C, FIG. 4C illustrates eight images grouped into four bedroom clusters 430, 432, 434, and 436, in accordance with some implementations of the present disclosure. In some implementations, the clusters can represent outputs of the space grouping system 116 and the spectral clustering system 412. Cluster 430 includes images of Bedroom 1 and cluster 432 includes images of Bedroom 2, grouped based on overlapping spatial features such as furniture arrangements and wall structures. Additionally, cluster 434 includes Bedroom 3 and cluster 436 includes Bedroom 4.

Referring now to FIG. 4D, FIG. 4D illustrates a structured representation 440 of the labeled room clusters derived from FIG. 4C, in accordance with some implementations of the present disclosure. In some implementations, the representation can include classifications of rooms and beds. For example, Bedroom 1 is associated with one Queen Bed and corresponds with Cluster 430. Similarly, Bedrooms 2, 3, and 4 are associated with individual Queen Beds and are linked to clusters 432, 434, and 436, respectively. Additionally, the representation can include information about bathrooms, such as Bathroom 1 with a toilet and shower and Bathroom 2 with a bathtub and toilet.

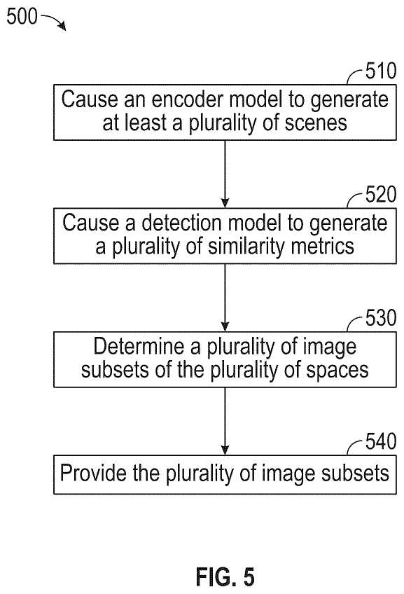

Now referring to FIG. 5, each block of method 500 includes a computing process that can be performed using any combination of hardware, firmware, and/or software. For example, various functions can be executed by one or more processors accessing instructions stored in memory. The method can also be implemented as computer-usable instructions on storage media or provided as a standalone application, a hosted service, or via an API. While described with respect to the system of FIG. 1A, the method 500 can also be executed by other systems or combinations of systems described herein.

FIG. 5 is a flow diagram showing a method 500 for causing an encoder model to generate, causing a detection model to generate, determining, and/or providing, in accordance with some implementations of the present disclosure. Various operations of method 500 can relate to improving the efficiency and accuracy of image-based scene classification and grouping. Existing systems often rely on manually annotated datasets and rigid processing pipelines, which can lead to inefficiencies and limited scalability. The existing technological problems can arise when these systems fail to dynamically process or group images. Method 500 of FIG. 5 can solve these technological problems by implementing self-supervised pretraining, pairwise similarity-based detection, and clustering models, thereby improving the scalability and precision of scene classification and space grouping.

The method 500, at block 510, includes causing an encoder model to identify at least one scene of the plurality of scenes for each image of the plurality of images (e.g., of bedrooms, bathrooms, living rooms, and kitchens). That is, the processing circuits (e.g., processing circuitry) can identify, using an encoder model, at least one space type of a plurality of space types for each image of the plurality of images of a plurality of accommodations of the hotel or the rental property. In some implementations, the encoder model (e.g., a first model of a plurality of models used in method 500) can be configured to process images using neural network architectures, feature extraction algorithms, or scene classification techniques, and/or any combinations thereof. The encoder model can be trained and/or implemented to identify spatial patterns, detect object relationships, and/or tag image attributes. In some implementations, causing the encoder model to identify the at least one scene of the plurality of scenes for each image of the plurality of images can include the processing circuits tagging one or more objects in at least one image of the plurality of images. In some implementations, causing the encoder model to identify the at least one scene of the plurality of scenes for each image of the plurality of images can include the processing circuits determining a scene of the at least one scene in the at least one image of the plurality of images. In some implementations, causing the encoder model to identify the at least one scene of the plurality of scenes for each image of the plurality of images can include the processing circuits identifying one or more features in the at least one image of the plurality of images.

The method 500, at block 520, includes causing a detection model to generate a plurality of similarity metrics of a plurality of image pairs corresponding with a plurality of spaces of at least one of the plurality of scenes. That is, the processing circuits (e.g., processing circuitry) can generate, using a detection model, a plurality of similarity metrics of a plurality of image pairs corresponding with the one or more spaces of at least one of the plurality of space types. In some implementations, the detection model (e.g., a second model of a plurality of models used in method 500) can be a Siamese network, convolutional neural network (CNN), transformer-based model, and/or any other machine learning model capable of processing paired inputs. The detection model can be trained and/or implemented to extract features, compare embeddings, and generate similarity metrics. Additionally, the plurality of spaces can include at least one of a bedroom, a bathroom, a kitchen, a living room, an entryway, a dining area, a laundry room, an office, a balcony, a patio, a garage, a storage area, or one or more outdoor spaces. In some implementations, the at least one similarity metric of the plurality of similarity metrics can correspond to a pairwise overlap score (e.g., spatial consistency, object alignment, or structural similarity) between a first image of the plurality of images with the at least one scene and a second image of the plurality of images with the at least one scene. Additionally, causing the detection model to generate the plurality of similarity metrics can include extracting, using a shared neural network (e.g., CNNs) of the detection model, one or more feature vectors of the first image and the second image (e.g., a first feature vector of the first image and a second feature vector of the second image). In some implementations, causing the detection model to generate the plurality of similarity metrics can include the processing circuits combining, using a vector function (e.g., concatenation, addition, or dot product) corresponding to a pairwise processing (e.g., embedding comparison) of one or more components of the one or more feature vectors (e.g., the first vector of the first image and second feature vector of the second image), the one or more feature vectors to output a combined feature vector (e.g., joint embedding, fused representation, or unified vector).

In some implementations, causing the detection model to generate the plurality of similarity metrics can include the processing circuits transforming the combined feature vector using a dense layer (e.g., linear transformation, weighted projection, or dimensionality reduction) of the detection model to generate an intermediate score (e.g., similarity estimate, alignment score, or relevance metric). The vector function can represent an operation such as element-wise multiplication, addition, concatenation, and/or subtraction applied to the feature vectors to produce a combined representation that encodes relationships between the two images. The pairwise processing can include aligning the feature vectors in dimensional space, applying the vector function to combine them, and/or preparing the resulting combined vector for transformation by the dense layer. That is, the pairwise processing can normalize both feature vectors to unit length, ensure they have identical dimensionality (e.g., both 512 components), apply the selected vector function (e.g., element-wise multiplication), and/or output a combined vector of the same or extended dimensionality for subsequent dense layer transformation. For example, to perform pairwise processing if the first feature vector is [0.2, 0.8, 0.5] and the second feature vector is [0.4, 0.5, 0.9], the system can normalize each vector to unit length, then apply element-wise multiplication to produce [0.08, 0.40, 0.45], which can then be passed to the dense layer to compute an intermediate similarity score. In some implementations, causing the detection model to generate the plurality of similarity metrics can include the processing circuits applying an activation function (e.g., sigmoid, ReLU, or softmax) to output the pairwise overlap score (e.g., similarity percentage, spatial alignment, or matching score).

In some implementations, the plurality of similarity metrics can be encoded within a similarity matrix (e.g., heatmap, two-dimensional array). That is, the similarity matrix can include a two-dimensional (2D) array and each element of the 2D array can correspond to a similarity metric (e.g., representing alignment strength, spatial overlap, or object correspondence) between a pair of images of the plurality of images. For example, the similarity matrix can be represented as a heatmap. In this example, the heatmap can include degrees of similarity between the plurality of image pairs using a color gradient (e.g., darker colors for lower similarity and lighter colors for higher similarity). In some implementations, the processing circuits can update the detection model based at least on (i) annotated positive image pairs, (iii) self-supervised positive image pairs, and (iii) negative image pairs. For example, the self-supervised positive image pairs can be generated by applying, by the processing circuits, one or more transformations including at least one of cropping, rotation, scaling, or color space adjusting to one or more images of the plurality of images. In another example, the annotated positive image pairs can be generated by determining, by the processing circuits, overlap between one or more views of a same space of the plurality of spaces. In this example, the annotated positive image pairs can be pairs of images manually labeled as depicting the same physical space, selected from a dataset of property images with verified space-level annotations. In yet another example, the negative image pairs can be generated by determining, by the processing circuits, a first image of a first space within the at least one scene and a second image of a second space within the at least one scene.

The method 500, at block 530, includes determining a plurality of image subsets of the plurality of spaces of the plurality of images corresponding with the at least one scene of the plurality of scenes. In some implementations, the plurality of image subsets (e.g., grouped bedrooms, clustered living spaces, or categorized outdoor areas) can be determined based at least on a grouping of the plurality of images according to the plurality of similarity metrics. Additionally, at least one of the plurality of image subsets can correspond with at least one space of the plurality of spaces. In some implementations, the plurality of image subsets can further be determined based at least on a space count of at least one scene of the plurality of scenes. Additionally, determining the plurality of image subsets can include applying a clustering function (e.g., k-means, spectral clustering, or agglomerative clustering) to the plurality of similarity metrics to cluster the plurality of images into the plurality of image subsets corresponding to a space (e.g., bedroom, bathroom, living room) of the plurality of spaces (e.g., bedrooms, bathrooms, and/or indoor/outdoor or mixed spaces).

Additionally and/or in combination, the method 500, at block 530 can include generating, using the plurality of similarity metrics, an ordered presentation of the plurality of accommodations of the plurality of images. That is, the ordered presentation can be ordered by grouping the plurality of images into a plurality of image subsets based at least on the plurality of similarity metrics. For example, each image subset of the plurality of image subsets can correspond to a space (e.g., Bedroom 1, Bedroom 2, Bedroom 3) of the one or more spaces. That is, the ordered presentation can include at least one of a slide show, at least one video, carousel, gallery, or a combination of one or more images and videos. For example, the ordered presentation can display images of grouped bedrooms sequentially in a carousel format or as videos. For example, the ordered presentation can present categorized outdoor areas in a slide show.

The method 500, at block 540, includes providing the plurality of image subsets of the plurality of images. The image subsets can be provided to an interface system (e.g., web-based application, mobile application, display system, API, and/or any visualization platform). That is, the processing circuits (e.g., processing circuitry) can provide, to an interface system, the ordered presentation for presentation. For example, the processing circuits can transmit grouped images including metadata identifying the room type to a mobile application for user interaction. In another example, the processing circuits can send clustered spaces to a web-based interface for generating interactive property tours. In some implementations, the provided image subsets can include metadata identifying a plurality of sub-spaces. For example, at block 510, the processing circuits can determine a sub-space of the at least one image of the plurality of images based at least on the one or more objects and the one or more features. The sub-space can be embedded or otherwise stored as metadata to be included with the grouped images generated at block 530. In some implementations, the processing circuits can embed the metadata in each image by encoding it into the metadata fields (e.g., EXIF or XMP metadata) of the image file. For example, metadata describing a sub-space as a “walk-in closet” can be added to the metadata attributes of the image file for retrieval and display. In some implementations, the processing circuits can store the metadata in each image by linking it to an external database. For example, each image can include a unique identifier that corresponds to a record in the database, where the record contains sub-space metadata such as features or objects.

The term “coupled,” as used herein, means the joining of two members directly or indirectly to one another. Such joining can be stationary (e.g., permanent or fixed) or moveable (e.g., removable or releasable). Such joining can be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic. For example, circuit A communicably “coupled” to circuit B can signify that the circuit A communicates directly with circuit B (i.e., no intermediary) or communicates indirectly with circuit B (e.g., through one or more intermediaries).

The implementations described herein have been described with reference to drawings. The drawings illustrate certain details of specific implementations that implement the systems, methods, and programs described herein. Describing the implementations with drawings should not be construed as imposing on the disclosure any limitations that can be present in the drawings.

It should be understood that no claim element herein is to be construed under the provisions of 35 U.S.C. § 112 (f), unless the element is expressly recited using the phrase “means for.”

As used herein, the term “circuit” can include hardware structured to execute the functions described herein. In some implementations, each respective “circuit” can include machine-readable media for configuring the hardware to execute the functions described herein. The circuit can be embodied as one or more circuitry components including, but not limited to, processing circuitry, network interfaces, peripheral devices, input devices, output devices, sensors, etc. In some implementations, a circuit can take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” can include any type of component for accomplishing or facilitating achievement of the operations described herein. In a non-limiting example, a circuit as described herein can include one or more transistors, logic gates (e.g., NAND, AND, NOR, OR, XOR, NOT, XNOR), resistors, multiplexers, registers, capacitors, inductors, diodes, wiring, and so on.

The “circuit” can also include one or more processors and/or processing circuitry communicatively coupled to one or more memory or memory devices. In this regard, the one or more processors can execute instructions stored in the memory or can execute instructions otherwise accessible to the one or more processors. In some implementations, the one or more processors can be embodied in various ways. The one or more processors can be constructed in a manner sufficient to perform at least the operations described herein. In some implementations, the one or more processors can be shared by multiple circuits (e.g., circuit A and circuit B can include or otherwise share the same processor, which, in some example implementations, can execute instructions stored, or otherwise accessed, via different areas of memory). Alternatively or additionally, the one or more processors can be structured to perform or otherwise execute certain operations independent of one or more co-processors.

In other example implementations, two or more processors can be coupled via a bus to allow independent, parallel, pipelined, or multi-threaded instruction execution. Each processor can be implemented as one or more processors, ASICs, FPGAs, GPUs, TPUs, digital signal processors (DSPs), or other suitable electronic data processing components structured to execute instructions provided by memory. The one or more processors can take the form of a single core processor, multi-core processor (e.g., a dual core processor, triple core processor, or quad core processor), microprocessor, etc. In some implementations, the one or more processors can be external to the apparatus, in a non-limiting example, the one or more processors can be a remote processor (e.g., a cloud-based processor). Alternatively or additionally, the one or more processors can be internal or local to the apparatus. In this regard, a given circuit or components thereof can be disposed locally (e.g., as part of a local server, a local computing system) or remotely (e.g., as part of a remote server such as a cloud-based server). To that end, a “circuit” as described herein can include components that are distributed across one or more locations.

An exemplary system for implementing the overall system or portions of the implementations might include general-purpose computing devices in the form of computers, including a processing unit, a system memory, and a system bus that couples various system components including the system memory to the processing unit. Each memory device can include non-transient volatile storage media, non-volatile storage media, non-transitory storage media (e.g., one or more volatile or non-volatile memories), etc. In some implementations, the non-volatile media can take the form of ROM, flash memory (e.g., flash memory such as NAND, 3D NAND, NOR, 3D NOR), EEPROM, MRAM, magnetic storage, hard disks, optical disks, etc. In other implementations, the volatile storage media can take the form of RAM, TRAM, ZRAM, etc. Combinations of the above are also included within the scope of machine-readable media. In this regard, machine-executable instructions include, in a non-limiting example, instructions and data, which cause a general-purpose computer, special purpose computer, or special purpose processing machines to perform a certain function or group of functions. Each respective memory device can be operable to maintain or otherwise store information relating to the operations performed by one or more associated circuits, including processor instructions and related data (e.g., database components, object code components, script components), in accordance with the example implementations described herein.

It should also be noted that the term “input devices,” as described herein, can include any type of input device including, but not limited to, a keyboard, a keypad, a mouse, joystick, or other input devices performing a similar function. Comparatively, the term “output device,” as described herein, can include any type of output device including, but not limited to, a computer monitor, printer, facsimile machine, or other output devices performing a similar function.

It should be noted that although the diagrams herein can show a specific order and composition of method steps, it is understood that the order of these steps can differ from what is depicted. In a non-limiting example, two or more steps can be performed concurrently or with partial concurrence. Also, some method steps that are performed as discrete steps can be combined, steps being performed as a combined step can be separated into discrete steps, the sequence of certain processes can be reversed or otherwise varied, and the nature or number of discrete processes can be altered or varied. The order or sequence of any element or apparatus can be varied or substituted according to alternative implementations. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure can be accomplished with standard programming techniques with rule-based logic and other logic to accomplish the various database searching steps, correlation steps, comparison steps, and decision steps.

While this specification contains many specific implementation details, these should not be construed as limitations on the scope of any implementations or of what can be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Having now described some illustrative implementations and implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act, or element can include implementations where the act or element is based at least in part on any information, act, or element.

Any implementation disclosed herein can be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation can be included in at least one implementation. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The foregoing description of implementations has been presented for purposes of illustration and description. It is not intended to be exhaustive or to limit the disclosure to the precise form disclosed, and modifications and variations are possible in light of the above teachings or can be acquired from this disclosure. The implementations were chosen and described in order to explain the principles of the disclosure and its practical application to enable one skilled in the art to utilize the various implementations and with various modifications as are suited to the particular use contemplated. Other substitutions, modifications, changes, and omissions can be made in the design, operating conditions and implementation of the implementations without departing from the scope of the present disclosure as expressed in the appended claims.

What is claimed is:

1. A system for grouping a plurality of images associated with a plurality of scenes, the system comprising:
processing circuitry configured to:
cause an encoder model to identify at least one scene of the plurality of scenes for each image of the plurality of images;
cause a detection model to generate a plurality of similarity metrics of a plurality of image pairs corresponding with a plurality of spaces of at least one of the plurality of scenes;
determine a plurality of image subsets of the plurality of spaces of the plurality of images corresponding at least one of the plurality of scenes, the plurality of image subsets are determined based at least on a grouping of the plurality of images according to the plurality of similarity metrics, wherein at least one of the plurality of image subsets corresponds with at least one space of the plurality of spaces; and
provide the plurality of image subsets of the plurality of images.

2. The system of claim 1, wherein causing the encoder model to identify the at least one scene of the plurality of scenes for each image of the plurality of images comprises at least one of:
tagging one or more objects in at least one image of the plurality of images;
determining a scene of the plurality of scenes of the at least one image of the plurality of images; or
identifying one or more features in the at least one image of the plurality of images.

3. The system of claim 2, wherein the processing circuitry is configured to:
determine a sub-space of the at least one image of the plurality of images based at least on the one or more objects and the one or more features, wherein the at least one image of the plurality of images of the plurality of image subsets comprise metadata corresponding to the sub-space.

4. The system of claim 1, wherein at least one similarity metric of the plurality of similarity metrics corresponds to a pairwise overlap score between a first image of the plurality of images with the at least one scene and a second image of the plurality of images with the at least one scene.

5. The system of claim 4, wherein causing the detection model to generate the plurality of similarity metrics comprises:
extracting, using a shared neural network of the detection model, a first feature vector of the first image and a second feature vector of the second image;
combining, using a vector function corresponding to a pairwise processing of one or more components of the first feature vector and the second feature vector, the first feature vector and the second feature vector to output a combined feature vector;
transforming the combined feature vector using a dense layer of the detection model to generate an intermediate score; and
applying an activation function to output the pairwise overlap score.

6. The system of claim 1, wherein the processing circuitry configured to:
update the detection model based at least on (i) annotated positive image pairs, (ii) self-supervised positive image pairs, and (iii) negative image pairs;
wherein the self-supervised positive image pairs are generated by applying one or more transformations comprising at least one of cropping, rotation, scaling, or color space adjusting to one or more images of the plurality of images, and wherein the annotated positive image pairs are generated by determining overlap between one or more views of a same space of the plurality of spaces, and wherein the negative image pairs are generated by determining a first image of a first space within the at least one scene and a second image of a second space within the at least one scene.

7. The system of claim 6, wherein the plurality of similarity metrics are encoded within a similarity matrix, the similarity matrix comprising a two-dimensional (2D) array, and wherein each element of the 2D array corresponding to a similarity metric between a pair of images of the plurality of images, and wherein the similarity matrix is represented as a heatmap, the heatmap comprising degrees of similarity between the plurality of image pairs using a color gradient.

8. The system of claim 1, wherein the plurality of spaces comprise at least one of a bedroom, a bathroom, a kitchen, a living room, an entryway, a dining area, a laundry room, an office, a balcony, a patio, a garage, a storage area, or one or more outdoor spaces.

9. The system of claim 1, wherein the plurality of image subsets are determined further based at least on a space count of at least one of the plurality of scenes, and wherein determining the plurality of image subsets comprises applying a clustering function to the plurality of similarity metrics to cluster the plurality of images into the plurality of image subsets corresponding to a space of the plurality of spaces.

10. A method for grouping a plurality of images associated with a plurality of scenes, comprising:
causing, by one or more processing circuits, a first model to identify at least one scene of the plurality of scenes for each image of the plurality of images;
causing, by the one or more processing circuits, a second model to generate a plurality of similarity metrics of a plurality of image pairs corresponding with a plurality of spaces of at least one of the plurality of scenes;
determining, by the one or more processing circuits, a plurality of image subsets of the plurality of spaces of the plurality of images corresponding with at least one of the plurality of scenes, the plurality of image subsets are determined based at least on a grouping of the plurality of images according to the plurality of similarity metrics, wherein at least one of the plurality of image subsets corresponds with at least one space of the plurality of spaces; and
providing, by the one or more processing circuits to an interface system, the plurality of image subsets of the plurality of images.

11. The method of claim 10, wherein causing the first model to identify the at least one scene of the plurality of scenes for each image of the plurality of images comprises at least one of:
tagging one or more objects in at least one image of the plurality of images;
determining a scene of the plurality of scenes in the at least one image of the plurality of images; or
identifying one or more features in the at least one image of the plurality of images.

12. The method of claim 10, wherein at least one similarity metric of the plurality of similarity metrics corresponds to a pairwise overlap score between a first image of the plurality of images with the at least one scene and a second image of the plurality of images with the at least one scene.

13. The method of claim 12, wherein causing the second model to generate the plurality of similarity metrics comprises:
extracting, using a shared neural network of the second model, one or more feature vectors of the first image and the second image;
combining, using a vector function corresponding to a pairwise processing of one or more components of the one or more feature vectors, the one or more feature vectors to output a combined feature vector;
transforming the combined feature vector using a dense layer of the second model to generate an intermediate score; and
applying an activation function to output the pairwise overlap score.

14. The method of claim 10, further comprising:
updating, by the one or more processing circuits, the second model based at least on (i) annotated positive image pairs, (ii) self-supervised positive image pairs, and (iii) negative image pairs.

15. The method of claim 14, wherein the self-supervised positive image pairs are generated by applying one or more transformations comprising at least one of cropping, rotation, scaling, or color space adjusting to one or more images of the plurality of images, and wherein the annotated positive image pairs are generated by determining overlap between one or more views of a same space of the plurality of scenes, and wherein the negative image pairs are generated by determining a first image of a first space within the at least one scene and a second image of a second space within the at least one scene.

16. The method of claim 14, wherein the plurality of similarity metrics are encoded within a similarity matrix, the similarity matrix comprising a two-dimensional (2D) array, and wherein each element of the 2D array corresponding to a similarity metric between a pair of images of the plurality of images, and wherein the similarity matrix is represented as a heatmap, the heatmap comprising degrees of similarity between the plurality of image pairs using a color gradient.

17. The method of claim 10, wherein the plurality of spaces comprise at least one of a bedroom, a bathroom, a kitchen, a living room, an entryway, a dining area, a laundry room, an office, a balcony, a patio, a garage, a storage area, or one or more outdoor spaces.

18. The method of claim 10, wherein the plurality of image subsets are determined further based at least on a space count of at least one of the plurality of scenes, and wherein determining the plurality of image subsets comprises applying a clustering function to the plurality of similarity metrics to cluster the plurality of images into the plurality of image subsets corresponding to a space of the plurality of spaces.

19. One or more non-transitory computer readable media for determining and organizing one or more spaces of a hotel or a rental property corresponding with a plurality of images, the one or more non-transitory computer readable media having one or more instructions stored thereon that, upon execution by one or more processors, cause the one or more processors to:
identify, using an encoder model, at least one space type of a plurality of space types for each image of the plurality of images of a plurality of accommodations of the hotel or the rental property;
generate, using a detection model, a plurality of similarity metrics of a plurality of image pairs corresponding with the one or more spaces of at least one of the plurality of space types;
generate, using the plurality of similarity metrics, an ordered presentation of the plurality of accommodations of the plurality of images, wherein the ordered presentation is ordered by grouping the plurality of images into a plurality of image subsets based at least on the plurality of similarity metrics, and wherein each image subset of the plurality of image subsets corresponds to a space of the one or more spaces; and
provide, to an interface system, the ordered presentation for presentation.

20. The one or more non-transitory computer readable media of claim 19, wherein the ordered presentation comprises at least one of a slide show, at least one video, carousel, gallery, or a combination of one or more images and videos, and wherein the plurality of space types comprise at least one of a bedroom, a bathroom, a kitchen, a living room, an entryway, a dining area, a laundry room, an office, a balcony, a patio, a garage, a storage area, or one or more outdoor spaces.
